(19) United States
(12) Patent Application Publication
(10) Pub. No.: US 2013/0036108 A1
(43) Pub. Date: Feb. 7, 2013

(54) METHOD AND SYSTEM FOR ASSISTING USERS WITH OPERATING NETWORK DEVICES

(71) Applicant: Maxime Corbeau, Den Haag (NL)

(72) Inventor: Maxime Corbeau, Den Haag (NL)

(21) Appl. No.: 13/196,807

(22) Filed: Aug. 2, 2011

(51) Int. Cl. G06F 17/30

(52) U.S. Cl. 707/722; 707/769; 707/E17.014

(57) ABSTRACT

A method includes steps of: receiving data from a network by a web browser executed by a computer connected to the network, analyzing the data received for determining if the data received is transmitted by a network device, extracting keywords from the data transmitted by a network device, generating a query from the keywords extracted from the data received, sending the query through the network to a web interface of a support database providing support information about operating the network device, receiving from the network query results transmitted by the support database, and displaying the query results with the page transmitted by the network device.

### BACKGROUND

1. Technical Field

The present disclosure relates to a method and a system for assisting users with operating network devices.

2. Description of the Related Art

The amount of information digitally-transmitted through the networks such as Internet has increased dramatically over the last few years. To ensure the availability, integrity, and security of that information, the network infrastructures rely on multiple network devices such as firewalls, routers, load-balancers and others. Like any other man-made objects, these devices may present flaws such as hardware faults or software bugs that may prevent these devices from functioning as expected. Such flaws may compromise the availability, integrity or security of the information transmitted. In order to mitigate these risks, network device manufacturers provide support information to assist network administrators with working around or correcting known problems.

Most network device manufacturers have made this support information available via Internet databases. Despite offering real help to network administrators, this approach presents two major drawbacks. Firstly, the database information is not displayed to the user when operating on a network device and the user has to manually search for this information. Secondly, while searching through the databases, the user may not be able to find the information searched for due to various reasons such as using inappropriate search keywords or filters.

Generally the network devices have a set-up interface comprising a web interface configured to be accessed through the network using a web browser software executed by a terminal connected to the network. Thus the software of the network devices could be modified so as to allow the network devices to query themselves a database. However some network devices do not have Internet connectivity. Therefore accessing an Internet database would involve carrying out modifications of the network infrastructure, which may be not possible due to network security policies. In addition relying on the network devices themselves to query a database would require to change and maintain all the different versions of device software released for each device and each time a database architecture or access is changed. Moreover this would generate duplication of accesses if a same user operates several identical network devices which redundantly request a same information.

In addition, due the multiplicity of network device types, manufacturers of these devices and support database interface types (query and query result formats), the access to information relative to such network devices would involve important software development costs and maintenance.

Thus it is desirable to use information provided by the network devices to generate queries to a support database without requiring manual operations from the users. It is further desirable to render the queries and the query results independent from a database web interface type. It is further desirable to display query results when the user operates on a network device. It is also desirable to centralize the execution of queries on a user computer as it may avoid the duplication of database queries and solve network connectivity issues.

However, these tasks appear to require very important development and maintenance costs. In fact the users may use different web browsers, and the web interfaces of the network devices and the related support databases may have different architectures even if they use substantially a same language (HTML, XML). Besides each time a web browser or web interface is updated, tools generating queries to a support database would need to be updated. Thus it is further desirable to design a tool for generating support database queries from pages of network device web interface and for displaying query results, this tool being independent from the web interfaces and architectures of the network devices and support databases.

### BRIEF SUMMARY

Embodiments concern a method for assisting users with operating network devices, the method comprising steps performed by a computer connected to a network of: receiving data from the network by a web browser executed by the computer, analyzing the data received for determining whether the data received is transmitted by a network device for which a user desires assistance, extracting keywords from the data transmitted by the network device, generating a query from the keywords extracted from the data received, sending the query through the network to a web interface of a support database providing support information about operating the network device, receiving from the network query results transmitted by the support database, and displaying the query results with a web page transmitted by the network device.

According to an embodiment, the method further comprises generating a query to the support database from keywords entered by a user or from keywords stored in a table.

According to an embodiment, the query generation comprises removing similar terms and then generic terms, from the keywords extracted.

According to an embodiment, analyzing the data received is performed by a process distinct from the web browser and asynchronously communicating with an additional component of the web browser by means of an event table in which the data received is inserted.

According to an embodiment, the method further comprises: associating in the event table the data received with events occurring within the web browser, each event being associated with an event occurrence order indicating a link to another event occurring after the event, selecting device identification patterns in a device profile table, to be applied to the received data, as a function of the event occurrence order corresponding to the event associated with the received data, and identifying a network device from which the data received is transmitted, by applying the selected device identification patterns to the received data, a particular network device being identified if one of the selected device identification patterns matches a part of the received data.

According to an embodiment, the method further comprises: collecting keyword values from support databases of network devices for which a user desires assistance, linking the values collected according to a tree-like structure using relations between values collected, and using the values collected and the links therebetween to extract the keywords from the data transmitted by a network device for which a user desires assistance.

According to an embodiment, the keyword value collection in a support database is performed periodically so as to prevent a disconnection from the support database due to a session timeout.

According to an embodiment, the keyword values collected and their tree-like structure are used to replicate the web interface of the support database inside a display area of a browser display window comprising another display area used to display a web page transmitted by a network device.

According to an embodiment, the keywords extraction comprises determining respective positions of web pages received from a network device into a tree-like structure defined by links between the web pages received, the keywords being extracted only from web pages selected according to their position in the tree-like structure.

According to an embodiment, the method further comprises processing query results received so that they fit in a display area of a browser display window comprising another display area used to display a web page transmitted by a network device.

According to an embodiment, processing the query results is performed by a process distinct from the web browser, and display of the processed query results is performed by an additional component of the web browser.

According to an embodiment, an additional component of the web browser asynchronously transmits data received by the web browser to a process distinct from the web browser, and the process parses the data transmitted to determine whether the data transmitted is received from one of the network devices for which a user desires assistance.

According to an embodiment, determining that the data received is transmitted by one of the network device is performed using identification patterns designed to match different parts of data in the data transmitted by a network device for which a user desires assistance.

According to an embodiment, extracting keywords from the data transmitted by a network device comprises selection of data to be extracted using patterns, and normalization of data extracted to remove redundancies and similarities within the data extracted.

According to an embodiment, the method further comprises transmitting a request to a network device at a predefined URL to retrieve a corrected bug list, receiving a corrected bug list from a network device, locating bug identifiers within the received corrected bug list, and removing from the query results transmitted by the support database the results concerning bug identifiers in the corrected bug list.

Other embodiments concern a computer system connected to a network and comprising a web browser configured to receive data from the network, the system being configured to: analyze the data received for determining whether the data received is transmitted by a network device for which a user desires assistance, extract keywords from the data transmitted by the network device, generate a query from the keywords extracted from the data received, send the query through the network to a web interface of a support database providing support information about operating the network device, receive from the network query results transmitted by the support database, and display the query results with a web page transmitted by the network device.

According to an embodiment, the computer system is further configured to generate a query to the support database from keywords entered by a user or from keywords stored in a table.

According to an embodiment, the computer system is further configured to generate the query by removing similar terms and then generic terms, from the keywords extracted.

According to an embodiment, the computer system further comprises a process and a web browser comprising an additional component, the web browser being configured to receive data from the network, the additional component being configured to transmit the data received to the process, and the process and the additional component being configured to asynchronously communicate with each other by means of an event table in which the data received is inserted.

According to an embodiment, the computer system is further configured to: associate in the event table the data received with events occurring within the web browser, each event being associated with an event occurrence order indicating a link to another event occurring after the event, select device identification patterns in a device profile table, to be applied to the received data, as a function of the event occurrence order corresponding to the event associated with the received data, and identify a network device from which the data received is transmitted, by applying the selected device identification patterns to the received data, a particular network device being identified if one of the selected device identification patterns matches a part of the received data.

According to an embodiment, the computer system is further configured to: collect keyword values from support databases of network devices for which a user desires assistance, link the values collected according to a tree-like structure using relations between values collected, and use the values collected and the links therebetween to extract the keywords from the data transmitted by a network device.

According to an embodiment, the computer system is further configured to periodically collect the keyword values in a support database so as to prevent a disconnection from the support database due to a session timeout.

According to an embodiment, the computer system is further configured to extract keywords from the data received from a network device by determining respective positions of web pages received from a network device in a tree-like structure defined by links between the web pages received, the keywords being extracted only from web pages selected according to their position in the tree-like structure.

According to an embodiment, the computer system is further configured to process query results received so that they fit in a display area of a browser display window comprising another display area used to display a web page transmitted by the network device.

According to an embodiment, the computer system further comprises a process distinct from the web browser and configured to process the query results received by the web browser, and an additional component of the web browser configured to display the processed query results.

According to an embodiment, the computer system further comprises an additional component of the web browser configured to asynchronously transmit all the data received by the web browser to a process distinct from the web browser, the process being configured to parse the data transmitted to determine whether the data transmitted is received from one of the network devices for which a user desires assistance.

According to an embodiment, the computer system is further configured to determine that the data received is transmitted by a network device by using identification patterns designed to match different parts of data in the data transmitted by a network device for which a user desires assistance.

According to an embodiment, the computer system is further configured to extract keywords from the data transmitted by a network device by selecting data to be extracted using patterns, and by normalizing data extracted to remove redundancies and similarities within the data extracted.

According to an embodiment, the computer system is further configured to transmit a request to a network device at a predefined URL to retrieve a corrected bug list, receive a corrected bug list from a network device, locate bug identifiers within the received corrected bug list, and remove from the query results transmitted by the support database the results concerning bug identifiers in the corrected bug list.

Other embodiments concern a computer readable medium configured to store computer executable code comprising instructions for controlling a computer, said instructions causing said computer to perform the steps of: receiving data from a network by a web browser executed by a computer connected to the network, analyzing the data received for determining whether the data received is transmitted by a network device for which a user desires assistance, extracting keywords from the data transmitted by the network device, generating a query from the keywords extracted from the data received, sending the query through the network to a web interface of a support database providing support information about operating the network device, receiving from the network query results transmitted by the support database, and displaying the query results with a web page transmitted by the network device.

According to an embodiment, the instructions cause the computer to perform the steps of generating a query to the support database from keywords entered by a user or from keywords stored in a table.

According to an embodiment, the instructions cause the computer to perform the steps of removing similar terms and then generic terms, from the keywords extracted, in order to perform the query generation.

According to an embodiment, the instructions cause the computer to perform the steps of executing a process distinct from the web browser, and an additional component of the web browser, the instructions cause the process to analyze the data received and asynchronously communicate with the additional component by means of an event table in which the data received is inserted.

According to an embodiment, the instructions cause the computer to perform steps of: associating in the event table the data received with events occurring within the web browser, each event being associated with an event occurrence order indicating a link to another event occurring after the event, selecting device identification patterns in a device profile table, to be applied to the received data, as a function of the event occurrence order corresponding to the event associated with the received data, and identifying a network device from which the data received is transmitted, by applying the selected device identification patterns to the received data, a particular network device being identified if one of the selected device identification patterns matches a part of the received data.

According to an embodiment, the instructions cause the computer to collect keyword values from support databases of network devices for which a user desires assistance, link the values collected according to a tree-like structure using relations between values collected, and use the values collected and the links therebetween to extract the keywords from the data transmitted by a network device.

According to an embodiment, the instructions cause the computer to perform the keyword value collection in a support database periodically so as to prevent a disconnection from the support database due to a session timeout.

According to an embodiment, the instructions cause an additional component of the web browser to use the keyword values collected and their tree-like structure to replicate the web interface of the support database inside a display area of a browser display window comprising another display area used to display a web page transmitted by a network device.

According to an embodiment, the instructions cause the computer to extract keywords by determining respective positions of web pages received from a network device in a tree-like structure defined by links between the web pages received, the keywords being extracted only from web pages selected according to their position in the tree-like structure.

According to an embodiment, the instructions cause the computer to extract process query results received so that they fit in a display area of a browser display window comprising another display area used to display a web page transmitted by the network device.

According to an embodiment, the instructions cause the computer to process query results by a process distinct from the web browser, and display the processed query results by an additional component of the web browser.

According to an embodiment, the instructions cause an additional component of the web browser to asynchronously transmit all the data received by the web browser to a process distinct from the web browser, and cause the process to parse the data transmitted to determine whether the data transmitted is received from one of the network devices for which a user desires assistance.

According to an embodiment, the instructions cause the computer to determine that the data received is transmitted by a network device by using identification patterns designed to match different parts of data in the data transmitted by a network device for which a user desires assistance.

According to an embodiment, the instructions cause the computer to extract keywords from the data transmitted by a network device by selecting data to be extracted using patterns, and normalizing data extracted to remove redundancies and similarities within the data extracted.

According to an embodiment, the instructions cause the computer to transmit a request to a network device at a predefined URL to retrieve a corrected bug list, receive a corrected bug list from a network device, locate bug identifiers within the received corrected bug list, and remove from the query results transmitted by the support database the results concerning bug identifiers in the corrected bug list.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown.

In the drawings:

FIG. 1 is a block diagram of a system according to one embodiment,

FIG. 2 is a flowchart of an initializing sequence executed by the system, according to one embodiment,

FIG. 3 is a list of events processed by the system, according to one embodiment,

FIG. 4 is a flowchart of a sequence executed by the system, according to one embodiment,

FIG. 5 is a structure of an event table managed by the system, according to one embodiment,

FIG. 6 is a flowchart of a sequence executed by the system, according to one embodiment,

FIGS. 7 and 8 are structures of a device profile table and a decision table used by the system, according to one embodiment,

FIG. 9 is a flowchart of sequence executed by the system, according to one embodiment,

FIG. 10 is a structure of an action profile table used by the system, according to one embodiment,

FIGS. 11A to 11D are screen parts displayed by the system, according to one embodiment,

FIGS. 12 and 13 are flowcharts of sequences executed by the system, according to one embodiment,

FIG. 14 is a tree-like structure of lists used by the system, according to one embodiment,

FIGS. 15A to 15E are screen parts displayed by the system, according to one embodiment,

FIG. 16 is a structure of a menu table used by the system, according to one embodiment,

FIG. 17 is a flowchart of sequence executed by the system, according to one embodiment,

FIGS. 18A and 18B are screen parts displayed by the system, according to one embodiment,

FIG. 19 is a flowchart of a sequence executed by the system, according to one embodiment,

FIG. 20 is a page displayed by the system, according to one embodiment,

FIG. 21 is a tree diagram representing the result of a parsing operation performed by the system, according to one embodiment,

FIGS. 22, 23 and 24 are flowcharts of sequences executed by the system, according to one embodiment,

FIG. 25 is a structure of a result table containing query results retrieved by the system, according to one embodiment,

FIGS. 26, 27, 28 and 29 are page parts displayed by the system, according to one embodiment,

FIG. 30 is a flowchart of a sequence executed by the system, according to one embodiment.

### DETAILED DESCRIPTION

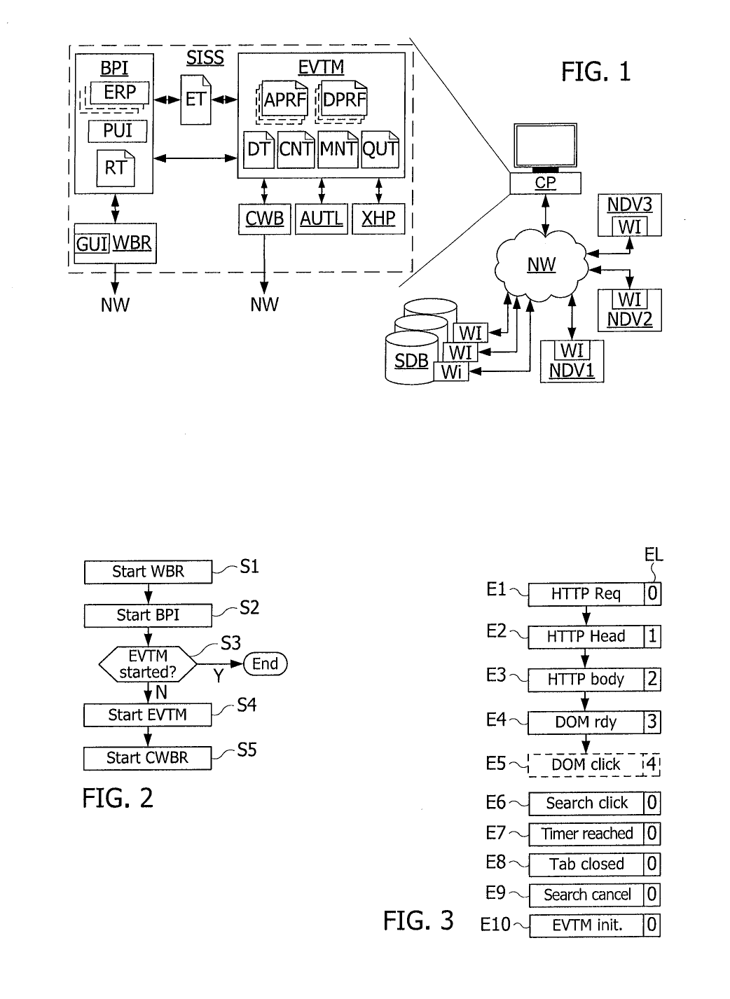

FIG. 1 represents a system referenced SISS providing users with support information when operating on network devices NDV1, NDV2, NDV3, according to one embodiment. System SISS may be a computer program or an application program running on a computer CP connected to the devices NDV1, NDV2, NDV3 via a network NW. Each of the devices NDV1, NDV2, NDV3 comprise a web interface WI which is normally intended to be accessed manually by users by means of a traditional web browser WBR. Support databases SDB contain support information regarding the devices NDV1, NDV2, NDV3. Each of these databases is accessible by means of a web interface WI which is also normally intended to be accessed manually by means of a traditional web browser. The network NW is for example the Internet network.

According to one embodiment, system SISS is configured to analyze data received by browser WBR when the user is operating on one of the devices NDV1, NDV2, NDV3, and to generate and send queries to the support database SDB in relation to the data received. To this purpose, system SISS comprises a software component BPI such as a “plugin” of browser WBR. Component BPI has an access to a software interface of browser WBR, for example an application programming interface (API), in such a way that it can modify an appearance of browser WBR and interact with a web engine thereof. For instance, component BPI is configured to listen to HTTP (HyperText Markup Language) or DOM (Document Object Model) events, and retrieve data associated with these events. DOM events allow event-driven programming languages like JavaScript, JScript, VBScript and Java to register various event handlers/listeners on the element nodes inside a DOM tree, e.g. HTML, XHTML, XUL and SVG documents. The actual technical term designating component BPI may vary depending on the targeted browser. For instance in Microsoft Internet Explorer, it may be referred to as an “add-on” or “Browser Helper Object” (BHO). In Mozilla Firefox it may be referred to as an “extension”.

System SISS further comprises an event management module EVTM which is configured to interact with component BPI so as to process events detected by component BPI, submit queries to one of the databases SDB and gather results from the databases.

Although web browsers rely on same standards to render web pages, each type of browser internal architecture is unique. Accordingly a distinct component BPI would need to be written for each type of web browser. Module EVTM and component BPI may be part of a same program. However in order to avoid having to code and maintain an event management module for each browser program, module EVTM and component BPI are designed as two separate programs so that module EVTM can be shared by multiple components, each being designed for a specific type of web browser.

Component BPI is configured to handle browser-specific events and send data formatted in a predefined way so that it can be processed by module EVTM, regardless of which component and web browser it is coming from. Depending on programming languages used to code component BPI and module EVTM, communication between component BPI and module EVTM may be achieved via different mechanisms, e.g. using RMI (Remote Method Invocation) if both are written in java, or using sockets if one is written in java and the other one in c#, . . . .

System SISS further comprises an XHTML parser XHP used by module EVTM to process web content XML, HTML and XHTML pages received by browser WBR from a network device NDVi or a database SDB. The web content processed by parser XHP is for example XML and HTML pages received either from network devices NDV1, NDV2, NDV3 or from databases SDB. Parser XHP extracts data from web pages received from the web interface WI of the network device to build database queries, or parses query results provided by support databases SDB.

Module EVTM comprises a set of profiles APRF, DPRF comprising one device profile DPRF for each type of network device NDV1, NDV2, NDV3, and one action profile APRF for each action to be performed. The profiles DPRF enable to use a single program, i.e. the web browser to access and retrieve data from web pages provided by the devices NDV1, NDV2, NDV3. The profiles APRF enable to use a same database interface to access (create custom search features) and retrieve data in databases SDB. Module EVTM comprises a controlled browser CWB which may be or not activated separately from browser WBR.

System SISS further comprises automation libraries AUTL used by module EVTM to control the browser CWB via scripting techniques. Libraries AUTL are for instance WATIR (http://watir.com/), Sahi (http://sahi.co.in/w/), or Selenium (http://seleniumhq.org/). Libraries AUTL may also be an application programming interface (API) of browser WBR itself as long as it allows for the interaction with a database SDB as background task so as to not disturb the user browsing experience on WBR. Libraries AUTL automate the process of searching within databases SDB using an action profile APRF. Module EVTM uses libraries AUTL instead of an HTTP library so as to remove the need for writing additional code routines to handle databases SDB application logic since it is automatically handled by browser CWB itself (example of AJAX-based select element). Also the use of libraries AUTL removes the need for writing separate database interfaces for each of databases SDB, as each database SDB is designed to be accessible via a web browser and may therefore be accessed via controlled browser CWB.

Component BPI comprises event reporters ERP that are configured to notify module EVTM about events occurring either inside component BPI or browser WBR. Event reporters ERP comprise a set of functions designed to report events that are considered relevant for assisting the user with operating a network device NDV. Reporters ERP are started in various fashions (e.g. as background processes when component BPI starts or are called by event listeners, but always follow the same logic:

they collect data (credentials provided by the user, network device web interface content, . . . ) and send that data to module EVTM for processing,

they first notify module EVTM so that it can decide whether to continue or stop,

they update an event table ET to communicate with module EVTM as the communication between module EVTM and component BPI is asynchronous.

Each reporter ERP may comprise one or more event listeners. An event listener is a function that is called when a particular event occurs. When a reporter ERP comprises several event listeners, the event listeners are nested within one another other, following an expected order of execution. An event triggering a top event listener is called the “triggering event”, other events declared within the top event listener, if any, are referred to as “subsequent events”.

FIG. 2 is a flowchart of an initialization sequence of module EVTM and component BPI, performed by browser WBR. This initialization sequence comprises steps S1 to S5. At step S1, browser WBR is launched manually by the user and connects to the web interface WI of one of the network devices NDV1, NDV2, NDV3. At step S2, component BPI is started automatically by browser WBR. Depending on the browser used, the initialization mechanism of component BPI may differ. For instance, initialization of a Microsoft Internet explorer add-on relies on various registry keys to locate and start COM class object as process (http://msdn.microsoft.com/en-us/library/bb250436%28VS.85%29.aspx).

At step S3, a verification is made if module EVTM is already running This may be achieved through various means depending on the operating system used, for instance Windows offers PSAPI to monitor which processes are running, Linux offers “ps” command. This verification is performed because module EVTM is designed as a standalone application that is started only once at first initialization of component BPI, and remains active until the operating system (OS) of the computer running the application is stopped. By remaining active module EVTM may offer a better user experience, for instance by keeping the controlled browser running to prevent authentication timeouts or maintain memory active to provide additional features such as caching. Step S4 is performed if a running instance of module EVTM is not detected. At this step, module EVTM is started through the use of a system call by component BPI, allowing module EVTM to start as a separate process (i.e. which would not terminate when component BPI is terminated). At step S5, module EVTM creates an instance of the controlled browser CWB. One instance of the controlled browser CWB is kept active until module EVTM is closed.

FIG. 3 represents a list of event types that may occur within browser WBR and be detected by component BPI. When browser WBR sends a HTTP request (event E1), an event reporter ERP instance “Page received” is triggered. When component BPI receives an HTTP header (event E2), an HTTP body (event E3) or “DOM ready” or DOM click events E4, E5, an event listener within the reporter ERP “Page received” is triggered for each event. Thus event E1 is a triggering event, and events E2, E3, E4, E5 are successive subsequent events to event E1.

When the user clicks on a search button within a web page displayed by browser WBR, component BPI triggers a corresponding event E6, and module EVTM triggers a reporter ERP “Manual search”. When component BPI receives a timer event E7 indicating a timer is reached, a reporter ERP “timer” is triggered. A timer may be triggered to execute a task or an action periodically, for example a search for a security update. When a tab or a window of browser WBR is closed (“Tab closed” event E8) by the user within a web page displayed by browser WBR, a reporter ERP “Tab closed” is triggered. When a search is cancelled by the user (“search cancel” event E9) within a web page displayed by browser WBR, a “search cancel” event reporter ERP is triggered. A reporter ERP “EVTM initialized” is triggered when component BPI detects that module EVTM has finished its initialization sequence and generates event E10 which may be used to search the database for the latest updates and present users with that information every time component BPI is started.

An order OR is assigned to each occurring event. This event order is consistent with an event occurrence order and allows to determine whether one event is expected to occur before or after another event. Since event E1 is a triggering event and events E2, E3, E4, E5 are successive subsequent events to event E1, events E1, E2, E3, E4, E5 are respectively associated with an event order raising from 0 to 4. The events E6 to E10 are associated with an event order OR equal to 0 since they are not linked with other events.

Event reporters ERP are categorized into actions. An action may be associated with one or more reporters ERP, but a reporter ERP however is associated with one and only one action. A list of event reporters ERP and their associated event and action is given in the following table:

TABLE 1

| Event | Event Reporter | Action | Action description |
|---|---|---|---|
| E2, E3, | Page received | Page | perform automatic analysis |
| E4, E5 | | analysis | of pages received from a web |
| | | | interface |
| E6 | Search started | Manual | allow users performing manual |
| | | search | searches |
| E7 | Timer, | Security | Perform automatic searches for |
| | EVTM initialized | updates | security updates |
| E8, E9 | Tab closed, | Stop | Cancel other actions |
| | Search cancel | | |

When an event is notified by component BPI to module EVTM, the latter starts a corresponding action. The only notification to module EVTM occurs on the triggering event, for instance “HTTP header” E1 for the “Page received” event reporter ERP and not on subsequent events such as E2-E5 for the same event reporter, otherwise module EVTM would end up processing each event as a separate action. Instead module EVTM is updated about subsequent events thanks to the event table ET.

Listening to DOM clicks (events E5) may be useful to ensure that only pages that the user clicks on are inspected. Event E5 may never occur as a user could request a page and then close browser WBR (or the window or tab displaying a web page). If earlier events E2 or E3 have not occurred or complete properly before an event E4 or E5 is detected, an error/exception would be thrown by browser WBR. In fact events E2 and E3 should have occurred for the corresponding page to be displayed. The corresponding event reporter ERP is configured to handle such an error/exception so as to exit.

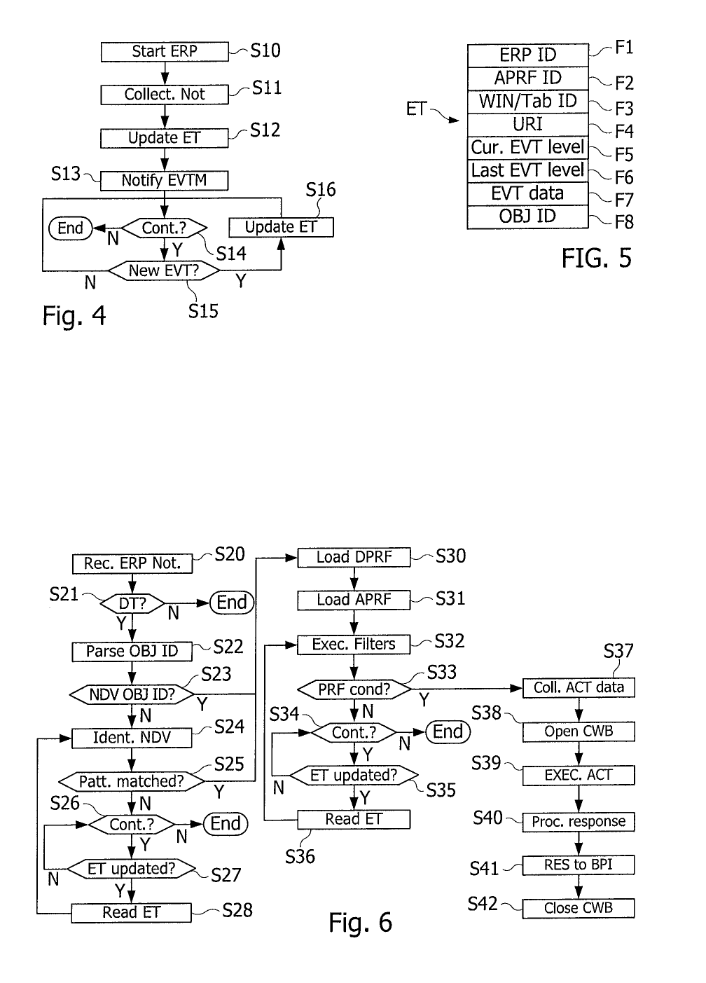

FIG. 4 is a flowchart of a sequence comprising steps S10 to S15 executed by an event reporter ERP to notify module EVTM or to update the event table ET. A step S10, a reporter ERP is started when its triggering event occurs. At step S11, notification information is collected. At step S12, the event table ET is updated. At step S13, the notification information is notified to module EVTM. At step S14, a test is performed to determine whether to wait for subsequent events or not. Event reporters with only one event listener would therefore stop the sequence there. This test prevents waiting indefinitely for subsequent events. As event E5 may never occur for a displayed page, no error/exception can be thrown. However the corresponding event reporter ERP may wait indefinitely for this event to occur, causing potential memory leaks and subsequently performance problems.

If no event is waited for at step S14, the sequence ends otherwise step S15 is performed. Step S15 is a waiting loop for subsequent events. If another event occurs at step S15, the step S16 is executed to update table ET and the execution of the sequence is continued from step S14 to update the event table ET. If no event occurs, the execution of the sequence is continued from step S14. In this manner, only one notification may occur since step S13 is executed only once.

Module EVTM and component PBI both interact with separate components, module EVTM may access to and receive query results from one of databases SDB while component PBI works with browser WBR. Consequently, the communication between module EVTM and component PBI is asynchronous, which means component PBI is not necessarily ready to respond to requests from module EVTM when needed and vice-versa. To manage such asynchronous communication, the event table ET stores data produced on one side so that it is still available when needed on the other side. In this manner, component BPI may receive for example a HTTP body while module EVTM is still processing a HTTP header.

FIG. 5 shows the structure of the event table ET. Table ET may comprises one or more lines each corresponding to the occurrence of an event as logged by its corresponding event reporter instance ERP. Each non-empty line of table ET comprises the followings fields:
“ERP ID” F1 which contains a unique identifier of an active event reporter instance ERP,
“APRF ID” F2 which contains a link to one of the action profiles APRF,
“WIN/Tab ID” F3 which contains an identifier for identifying which browser window and tab the event is related to; some events may be related to a specific window/tab such as an automatic search on a particular page, and some other events may be global, such as security updates searches,
“URI” F4 which when not empty contains an URI identifier (Unique resource Identifier) associated with the browser tab corresponding to the event and pointing to a page of the network device web interface when such event is associated with the processing of such a page,
“Cur. EVT order” F5 which indicates the event order OR associated with the current event,
“Last EVT order” F6 which indicates the last possible event order in the chain (used during a decision process),
“EVT data” F7 which contains data associated with the event, this data being sent as text so that it can be processed generically by module EVTM regardless of the nature of data (HTTP headers, HTTP body, . . . ),
“OBJ ID” F8 which contains object identifiers and corresponding object values of the received web page.

Field F1 is incremented for each new instance of an event reporter to allow determining the order of occurrence of instances based on their identifier. Field F1 also allows identifying which entries of table ET are related to a same event reporter instance ERP. This identification becomes important when several instances of the same ERP are running concurrently, for instance if a user triggers two instances of the “page received” event reporter ERP by opening two browser tabs to two network devices in a quick succession. Field F4 is filled only for events that are associated with a particular network device page such as E1, E2, E3, E4, and E5. Table ET keeps tracks of occurring events and related data, thus giving visibility on which actions are being processed by module EVTM, and information that is used to make decisions as to which actions should continue or stop when handling several concurrent actions. An example of table ET is given in Annex I. This table comprises eight lines each containing information relative to the occurrence of an event. For example field F7 contains a HTTP header if the corresponding event is E2, a HTTP body if the corresponding event is E3, and when user clicks on an element of a web page received from a device NDV, a copy of the XHTML code of that element. For instance if the user clicks on an “application” menu link, the copy of the HTML code of that element will be:

<a href=“/application”><span class=“label”> application </span> </a>

FIG. 6 is a flowchart of a sequence of steps S20 to S42 executed by module EVTM. At step S20, module EVTM receives from an event reporter ERP of component BPI a notification (sent at step S12) indicating that a new entry is inserted in table ET and which entry it is. At step S21, it is determined whether it is needed to continue or stop current and previous actions. Each previous action corresponds to an earlier occurrence of the sequence of FIG. 6. Step 21 may be performed by the sequence of FIG. 9 using a decision table DT such as the one of FIG. 8. If it is determined to stop the current action, the sequence execution is ended, else steps 22-25 are performed. Before the sequence execution is ended, module EVTM removes from table ET the entries corresponding to the current action. The removed entries have an ERP ID (field F1) matching the ERP ID received during the current action notification. At step S21, if it is determined to stop one or more previous actions, module EVTM removes each entry corresponding to the previous action to be stopped in table ET. In this manner the earlier instances of module EVTM and event reporters ERP can detect that their corresponding entries were removed from table ET and stop accordingly so that computing resources they occupy are released.

At steps S22-S25, module EVTM attempts to retrieve a device profile DPRF. The retrieving of such a profile enables module EVTM to obtain conditions relative to whether an action is performed or stopped as a function of a corresponding network device. Both action profiles APRF and device profiles DPRF contain conditions (called “action filters” and “device filters”) which must be met before the processing of the action can continue. These conditions are provided to define a criteria to perform a pertinent query. A same filter may be used either in a profile DPRF or APRF.

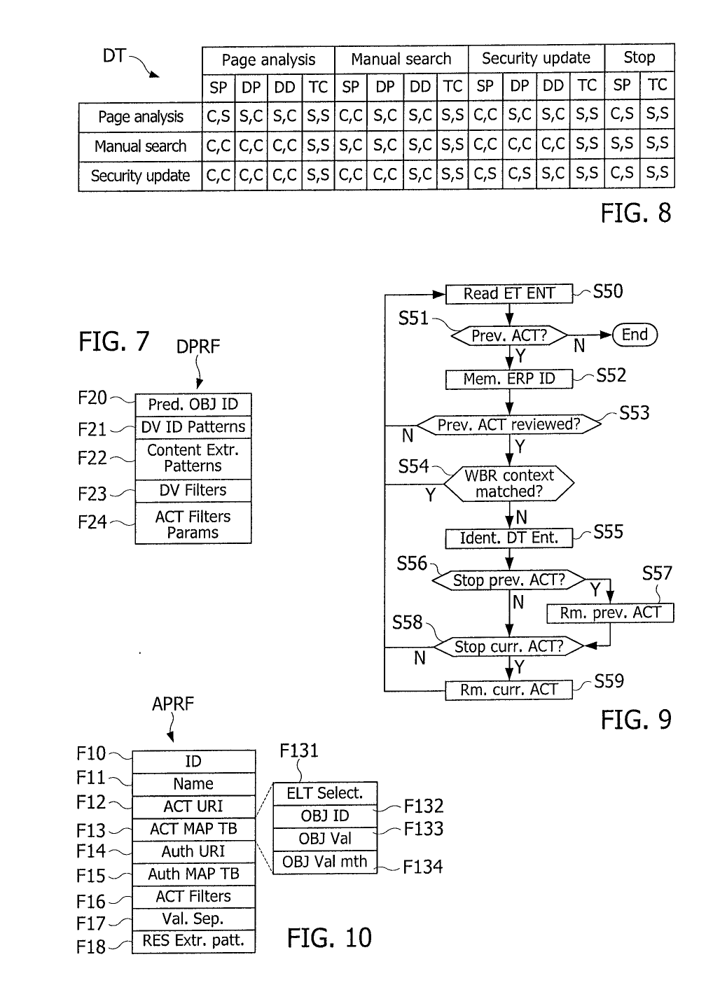

At steps S22, S23, a device profile DPRF is retrieved thanks to object identifier (field F8) in table ET, provided by the event reporter instance ERP if any. If a value is already provided by user (manual search) then the device profile can be identified directly without going through device detection. If no profile DPRF is identified the sequence execution continues at steps S24 to S28, otherwise the sequence execution continues from step S30. The device identification is achieved by trying to match event data (field F7 of table ET) with predefined device identification patterns. As shown in FIG. 7 a device profile DPRF comprises the following fields:

F20: predefined object identifiers and their corresponding object value, which allow identifying a device profile DPRF and limit the scope of the device profile to certain devices when such object identifiers are used to retrieve a device profile at step S23,
F21: device identification patterns which allow identifying a device profile DPRF and limit the scope of the device profile to certain devices when such device identification patterns are used to retrieve a device profile at step S24, S25,
F22: content extraction patterns, which are subdivided into exclusion patterns and inclusion patterns, these patterns being predefined XHTML processing patterns used to extract relevant content in the web pages received from a network device NDV to perform actions,
F23: device filters, which represent device-specific conditions that must be met before an action may be performed, and
F24: action filter parameters which are parameters for filters defined in action profiles APRF, and allow defining a filter inside an action profile to be applied to all devices, while adapting the functioning of that filter to network devices NDV associated with the device profile providing the action filter parameters.

If a device object identifier is not provided to module EVTM during a notification or later updates of table ET, or cannot be matched, module EVTM executes steps S24, S25 where it tries to match a device profile DPRF by attempting to match a device identification pattern F21 from one of device profiles. Device identification patterns are predefined processing patterns used on event data to attempt detecting relevant network devices NDV the user is operating on. Each device profile DPRF is reviewed to see if one of its device identification patterns F21 match. This is done as follows. First the pattern is selected only if its event order OR matches the current event order which is either the event order corresponding to the notification when received (transmitted at step S12), or the last read event order in table ET when iterating through the steps S24 to S28 and steps S32 to S36. Then if its event order matches a pattern match is attempted. If a pattern is successfully matched at step S25, step S30 is performed. If no pattern is matched a decision is made as to whether continuing the procedure at step S26. This decision only applies to the current action, and is based on two criteria. The first criterion is based on the event order information from the current event order. This criterion allows to determine that none of the device identification patterns (field F21) have an event order which will match a subsequent event. For example if current event order is 3 and last event order is 4, then the only remaining event is E4. Besides if the device identification patterns have 1, 2 and 3 as an event order, then there are no more device identification patterns to be matched during subsequent events. The second criterion is applied after verification of table ET. This criterion allows to determine whether the entries in table ET corresponding to the current action ACT have not been removed by another instance of module EVTM, thus ensuring actions are stopped when they should.

If the decision at step S26 is to continue the sequence, module EVTM enters a wait loop at steps S27, S26 during which it checks for updates regarding the current action to be made in table ET. Step S26 allows module EVTM to exit the procedure if needed.

Once an update to the event table ET regarding the current action is detected, module EVTM reads that update at step S28 in the same way as at step S20. Module EVTM then tries to perform a device identification from that update from steps S24. The steps S24 to S28 are repeated until a device is identified at step S24 or one of the criteria for stopping the sequence is met at step S26.

It can be noted that other conditions may be implemented such as a timer or counter value reached to ensure that module EVTM does not remain indefinitely in the loop between steps S24 and S28.

At step S30, module EVTM loads the device profile DPRF of the device as identified at step S22 or S24. At step S31, module EVTM retrieves an action profile APRF which describes how to perform the action associated with the current event reporter instance ERP. The action profile APRF is selected and loaded based on the notification received at step S20 (field F2 of table ET). Action profile APRF could be loaded just after S20, but waiting for a device profile DPRF to be successfully loaded at step S30, avoids unnecessarily doing so if step S30 is never reached, thus optimizing the loading of an action profile. Both device and action profiles DPRF, APRF contain filters (fields F23 and F16). These filters are calls to validation functions which ensure that the current network device web interface meets certain predefined conditions before one of databases SDB can be interrogated in order to avoid non-pertinent actions to be performed. The action filters (field F16 and F24) allow filtering on a per action basis and therefore apply regardless of the network device involved in the action. For instance the use an action filter may be provided to not process a page if the user navigates away from it. The device filters (field F23) only apply to devices which match the corresponding device profile DPRF. For instance, the device filters allow to exclude a help section of a particular device web interface. Each filter comprises an event order OR in order to specify when it should be used. Each filter further comprises a call to one or more functions which perform some processing on data given as parameters and returns a code indicating whether the condition it was called to verify is met or not. The filter function parameters may be the event data (field F7) or other variables reported by an event reporter ERP of component BPI. The filter function parameters may also be predefined in the profiles. Finally, parameters (field F24) may be defined in device profiles DPRF and passed to action filters APRF to adapt the action filters to a device or group of devices. For example a device filter may comprise the event order OR 1 and the function call “Is_help_section?(URL)” which return true if the URL parameter corresponds to a help section. An action filter may comprise the event order OR 3 or 4 and the function call “Is_page_final?(EVT Data)” or “Is_link?(EVT Data)”.

Once the device profile DPRF and the action profile APRF have been loaded at steps S30, S31, the filters (fields F23, F16) they contain are executed at step S32. Only the filters having an event order OR matching the current event order (field F6) are executed at this stage. At step S33, verification is made to check whether the conditions of the filters executed were met. If all the filters are executed because their event orders all are lower than or equal to the current event order and the conditions to be verified by all filters are satisfied, the sequence execution continues with collecting action data at step S37. Otherwise, i.e. if one or more filters cannot be executed because they have an event order higher than the current event order, the following tests are made (step S34). Either all the conditions of the filters executed are satisfied and module EVTM waits for the event table ET to be updated (steps S35 and S34) so that it can execute other filters when its current event order will match theirs, or one of the conditions of the filters is not satisfied and the sequence stops. Similarly to step S26, step S34 is also used to prevent module EVTM from waiting indefinitely for subsequent update of table ET.

The filters defined in the action or device profiles and executed at step S32 may be used to increase the pertinence of results by stopping actions which do not meet predefined search conditions. Filters may be defined in such profiles so as to be executed on a per action of per device basis, but also if the components needed for their execution, such as the XHTML parser, are only available from module EVTM. However, other generic filters that should be applied systematically for each event occurring in browser WBR may be defined in the event reporters ERP themselves. For instance, processing cascading style sheet (CSS) code, JavaScript (JS) code or images received from the network devices may not be suitable for the search of keywords, accordingly the E1 and/or E2 event reporters may be configured to inspect the request URL or response Content-type HTTP header and proceed with notifying the Event Manager and updating the table ET only if the content requested or served is HTML or XML code.

If at step S35, the event table ET updated, this table is read at steps S36, steps S32 to S36 are repeated until all conditions could be satisfied or decision is made to stop the sequence.

At step S37, action data is collected. At step S38, an instance of browser CWB is run and a browser tab opened to access the action URI as specified in the profile APRF selected. A browser tab inside the instance of controlled browser CWB started at step S5 could also be opened. At step S39, the action defined by a mapping table in profile APRF (Field F13, F15 in FIG. 10) is performed using the running browser CWB tab opened at step 38. At step S40, the response obtained from a database SDB after performing the action, by the running instance of browser CWB is processed to extract results it may contain. Then at step S41, if results were successfully obtained during step S40, a display function of component BPI provided for displaying the results is called and gives the results as processed during step S40. Indeed there is no guarantee that the database SDB queried during execution of the action at step S39 will supply results. At step S42, if a new instance of browser CWB was started at step 38, the running instance is closed, otherwise if a tab was opened inside an existing instance of browser CWB, the tab opened is closed. At step S43, all entries in table ET corresponding to the current action are removed. This is achieved by deleting entries which ERP Instance ID (field F1) matches the ERP instance ID reported during the initial action notification received at step S20. This may free up resources by releasing the event reporter ERP from waiting for additional events. This also enables module EVTM from accepting further actions. Otherwise if table ET were not cleaned up, later instances of module EVTM may refuse to process further actions depending on the decision table DT rules, for instance users could only perform a single manual search, after which module EVTM would refuse to process subsequent manual searches, due to the decision made at step S21 allowing only one concurrent manual search.

As previously explained, there may be several actions being processed at the same time. The decision table DT is used to decide which of these actions should continue or stop (step S21). A one-to-many relationship between actions and event reporters ERP facilitates the decision process by reducing the number of entries in table DT and allowing an event reporter ERP to be added to or removed from actions without changing table DT. The decision making process only applies to actions that have a matching window/tab identifier so that component BPI offers a separate user experience on a window/tab basis, such as preventing loading of a page displayed in one browser tab, that may affect actions in other tabs.

In order to explain how actions are handled concurrently with regards to the decision process, the terms of previous, current, and new actions are defined as follows. A current action is the action being currently processed by a particular instance of module EVTM. Previous actions are actions which processing started before the current action and which are still being processed by earlier instances of module EVTM. New actions are actions which processing started after the current action and which are still being processed by newer instances of module EVTM. Any entry of the event table ET may be associated with a previous, current or new action at any given moment depending on which instance of module EVTM and its corresponding current action is chosen as a reference. In order to identify previous actions, an instance of module EVTM reviews all the entries in chronological order (from the top to bottom of the table in the example of Annex I). All entries having an ERP ID (field F1) lower than the ERP ID received in notification at step S20 correspond to previous actions. In order to remove entries related to previous actions, and due to the fact that there may be several concurrent instances of an event reporter ERP, writing asynchronously to table ET, causing table ET entries to be interlaced in some cases, identification of the previous and new actions is based on each action earliest entry. The criterion for removing entries for a particular action is based on whether they share the same event reporter ERP ID regardless of their position in table ET, instead of assuming that they should be contiguous. For instance, assuming oldest entries are at the top of the table ET in Annex I, and ERP ID 3540 is associated with the current action. ERP ID 3522 and 3525 are previous actions of ERP ID 3540 because their ERP ID (respectively entries 1 and 2) are lower than 3540, and 3550 is a new event because its ERP ID is greater than 3540.

FIG. 8 shows the content of the decision table DT. Table DT comprises three rows, three groups of four columns and one group of two columns. Each group of columns and each row correspond to a possible action. The first row and the first group of four columns of table DT correspond to the action “Page analysis”. The second row and the second group of columns correspond to the action “Manual search”. The third row and the third group of four columns correspond to the action “Security update”. The last group of two columns corresponds to the action “Stop”. The columns of each of the three first column groups respectively correspond to a Tab context “same Page” SP, “Different Page” DP, “Different Device” DD and “Tab Closed” TC. The columns of the last column group corresponding to the action “stop” respectively correspond to the Tab contexts SP and TC. The entries of table DT contains two letters each being equal to “S” meaning “stop” or “C” meaning “continue”. The first letter indicates whether the processing of a previous action should stop or continue, and the second letter whether the processing of the current action should stop or continue.

To use table DT, a row should first be selected according to the nature of the previous action. Then a column group should be selected as a function of the nature of the current action. Finally one column of the previously selected group or the last column of table DT should be selected as a function of a Tab context obtained by comparing the current action Tab with the previous action Tab.

To fully explain the use of table DT, the following examples are given in relation with the example of table ET in annex I. In a first example the current and previous actions are referenced 3540 and 3522 respectively. The current action is “Security update” and the previous action is “Manual search”. The context Tab is “same page” SP since the URIs of the two actions are the same. Therefore the entry to read in table DT is at the intersection of the second row (the previous action is a “Manual search”) and the first column of the third column group (the current action is a “Security update” and the Tab context is SP). The entry to consider contains “C,C”, meaning that the processing of both the previous and current actions should continue at step S21 (FIG. 6).

In a second example the current and previous actions are referenced 3544 and 3532 respectively. The current action is “Security update” and the previous action is “Page analysis”. The context Tab is “different page” DP since the URI of the two actions are the different but concern the same network device (referenced 10.10.10.2 in the URI). Therefore the entry to read in table DT is at the intersection of the first row (the previous action is a “Page analysis”) and the second column of the third column group (the current action is a “Security update” and the Tab context is DP. The entry to consider contains “S,C”, meaning that the processing of the previous action should stop and the one of the current actions should continue.

In a third example the current and previous actions are referenced 3555 and 3532 respectively. The current and previous actions are both “Page analysis”. The context Tab is DD since the URI of the two actions are different and concern two different network devices (referenced 10.10.10.1 and 10.10.10.2 in the URI). Therefore the entry to read in table DT is at the intersection of the first row and the third column of the first column group. The entry to consider contains “C,C”, meaning that the processing of both the previous and current actions should continue.

In a fourth example the current and previous actions are referenced 3550 and 3540 respectively. The current and previous actions are respectively “Security update” and “Stop”. The context Tab is TC since the current action is closing a Tab. Therefore the entry to read in table DT is at the intersection of the last row and the second column of the fourth column group. The entry to consider contains “S,S”, meaning that the processing of both the previous and current actions should stop.

The first entry (“C,S”) of table DT prevents multiple automatic searches on page refresh by allowing continuation of the previous action and interruption of the new action. The first entry (“C,C”) of the second column group allows concurrently automatic and manual searches. In addition, whenever a tab is closed (last column of table DT), the execution of both the current and previous actions is stopped (“S,S”).

FIG. 9 is a sequence executed at step S21 (FIG. 6) for a current action regarding other previous actions to determine whether these actions should be stopped. The sequence comprises steps S50 to S59. At step S50, table ET is read starting at the first event entry while retrieving the WIN/Tab ID of each action. At step S51, it is determined whether the entry read at step S50 corresponds to a previous action, that is if its ERP ID (field F1) is lower than the one received at S20, then execution of the sequence continues at step S52 otherwise it ends. An instance of module EVTM cannot rely on the fact that the table ET entry read at step S50 and corresponding to the notification it received at S20 will remain in table ET throughout the decision process as it may be removed by another instance of module EVTM in the meantime. Accordingly, an instance of module EVTM may never read that entry during step S50, which discards solutions whereby step S51 is used by module EVTM to identify that entry and stop the sequence accordingly. In this way, an instance of module EVTM can detect entries of table ET related to the current or new actions if their field F1 is greater than or equal to the one of entry read at S50.

At step S52, the ERP ID from entry read at step S50 is memorized. At step S53, if the previous action related to the entry read at step S50 was already reviewed, that this if the corresponding ERP ID was already memorized at step S52 for a previous entry of table ET, then the sequence continues at step S50 with reading a next entry in table ET, so as to avoid making redundant decisions on the same previous action. Otherwise the sequence continues at step S54. At step S54, if the browser contexts between the previous and the current action match, the decision process for the entry of table ET read at S50 continues at step S55, otherwise a next entry is read in table ET at step S50. Performing a verification on the browser context provides a good user experience, for instance to prevent a user accessing a network device page in a particular browser tab from interrupting the analysis of a network device page in another tab. Matching browser contexts are determined by comparing the field F4 of the entry related to the previous action (read at step S50) and the information received at step S20.

At step S55, the entry of decision table DT related to the previous action corresponding to the entry read at step S50 and the current action is identified. At step S56, the first letter of the entry retrieved in table DT is tested to determine whether the previous event should be stopped or not. Steps S57 and S58 are executed if the previous event should be stopped otherwise step S58 is executed. At step S57 all entries related to the previous event are removed from Table ET. This is achieved by looking up the entire table ET and removing any entry with an ERP ID matching the ERP ID memorized at step S52, so as to handle a situation of interlaced entries in table ET. At step S58 the second letter of the entry retrieved in table DT is tested to determine whether the current event should be stopped or not. Step S59 is executed if the current event should be stopped otherwise execution of the sequence continues at step S50 with reading a next entry in table ET. At step S58, a verification may be made to check whether the decision to stop the current action was already made for a previous entry of table ET, since the decision of stopping the current action involves removing related entries of table ET, and entries that were already removed cannot be removed again. This may be achieved by looking up table ET in an attempt to find entries related to the current action to confirm, if missing, that the current action was already stopped. Another solution would be to memorize the decision to stop the current action so as to save module EVTM from doing an additional lookup of table ET. At step S59 all entries related to the current event are removed from table ET based on the ERP ID received at step S20, in a similar way that entries for previous actions are removed at step S57. Steps S50 through S59 are repeated until the ERP ID of the entry read at step 50 is greater than or equal to the ERP ID of notification step S20. The sequence is also stopped if at step S50 there are not any more entries left to be read in table ET.

A decision making process involving the review of decision table DT only occurs at the beginning of each action when the corresponding instance of module EVTM performs step S21. In addition, each instance of module EVTM that reaches step S26 and/or step S34 also undergoes another decision process not involving the review of table DT but instead involving the review of table ET to check whether the entries of table ET corresponding to its corresponding action were removed by a new instance of module EVTM dealing with a new action and performing review of table DT at step S21. Decision process at steps S26 and S34 therefore allows a current action to be stopped by a new action without having the module EVTM instance associated with the current action process table DT for the new action. This results in both the module EVTM instance associated with the current action and the module EVTM instance associated with the new action to redundantly review table DT about each other's action. Thus the combination of steps S21, S26, and S34 optimizes the decision making process by limiting the number of reviews of table DT to one per action, preventing actions from making redundant decisions about each other, while allowing any action to stop itself and remove one or more of its previous actions or be stopped by a new action.

FIG. 10 shows the structure of the action profile APRF table. Each action profile in table APRF contains information necessary to perform a particular action, such as which page to request, what data to use for a query. Each entry of table APRF corresponds to an action profile comprises fields F10 to F18. Field F10 and contains a unique identifier for identifying an action profile. Field F11 contains a name used by component BPI. Field F12 contains the URI of a web page of a support database SBD where a request is to be made. Field F13 contains a mapping table for the web page identified by the action URI (field F12). Field F14 is the URI of a web authentication page, if access to the database SDB is subjected to an authentication of the user. Field F15 contains a mapping table for the web page identified by the authentication URI (field F14). Field F16 contains action filters which are conditions to be satisfied before queries to the database SDB can be sent. These conditions may comprise conditions global to the action. Field F17 contains a value separator which is a string to use for concatenating multiple values into one, typically a keyword. Field F18 contains result identification patterns which allows to identify individual results provided within a response from the database.

Each entry of each mapping tables (fields F13, F15) comprises:

an element selector F131 defining how to select an element, for example an Xpath string allowing to select an element in an XHTML page,
an object identifier F132 describing a type of search-related element found in a web page a support database SBD,
an object value F133 used as input to manipulation methods for interacting with the way to manipulate an element identified in a web page from the database SDB, identified by field F131, and
an object value method F134 defining how to retrieve the object value of the element selected by means of the element selector.

The element selector enables selecting an element in a web page. The element selector is for example a XML or XHTML tag that may appear in a web interface page of the database SDB. Searching in a support database SDB may differ from one network device manufacturer to another, depending on the way the database interfaces have been designed (elements layout, text, features . . . ). However the searching process presents similarities regardless of the database used and same key tasks can be identified, such as typing keywords in a text field and pressing a button to start the search. The object identifiers F132 represent those key tasks and the element selectors the way these key tasks are encoded in the web interface pages of the database. The same object identifiers can be reused multiple times across various database interfaces, thus allowing multiple interface supports and reducing complexity of code. By using object identifiers instead of element selectors, the code becomes independent from the actual code of the database web interfaces. If the structure of a support database web interface changes, one simply needs to update the relevant mapping tables (field object selector), and not the code itself. The object value is a value to be assigned to an element in the web page or used to manipulate an element, like for instance clicking a check-box if its object value is set to checked and the current check-box state is unchecked.

The object value is optional as not all manipulation methods require a value. For instance, one can assign a value to an input element and provide the manipulation method with that value. Clicking a button element however does not require the manipulation method to be provided with a value to assign to that button element. The object value method F133 may have the following values:
“device” meaning that predefined XHTML patterns are used to extract data from the web interface source code of the network device NDV1-NDV3,
“user”: meaning that the user is prompted for input via the user interface of component BPI and the input value is used as the object value, and
“default” meaning that a predefined value is assigned to the object value.

The method “device” is useful if the network device web interface is structured accordingly. If the variety of devices and discrepancies between devices are too high, “device” method may not be suitable as it could require too many code changes to be made and patterns to be created. The method “Default” may be used to reset values of certain objects if a same controlled browser instance CWB is used for multiple database queries. The method “Default” may also be used to create custom search actions from the same database interface (for example a security update and hidden client object to render results specifically for component BPI). This method also provides support for AJAX-based interfaces.

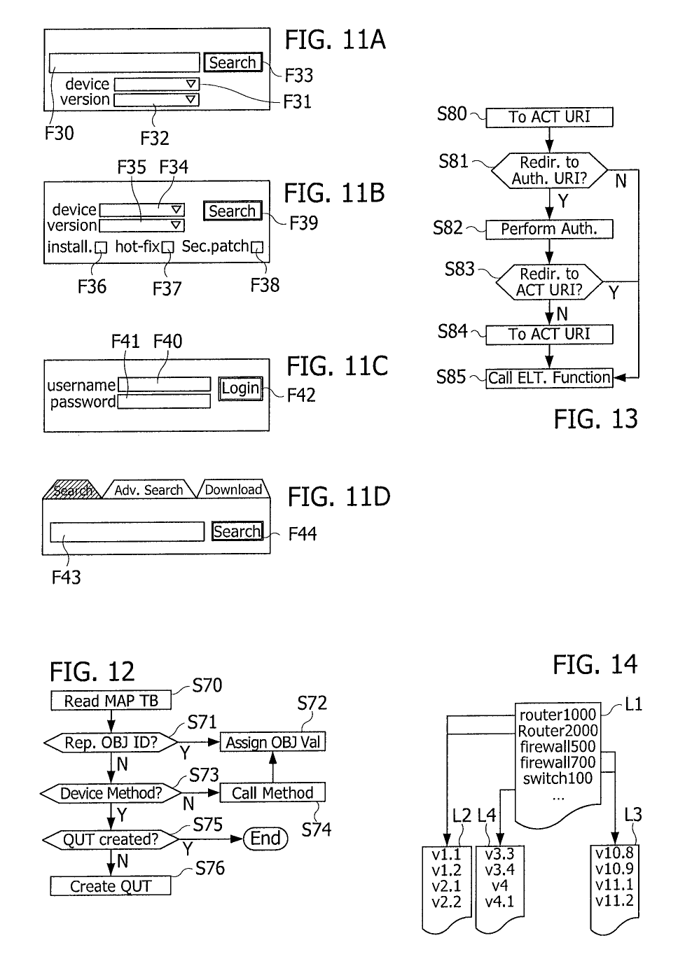

In order to illustrate a mapping table (fields F13, F15), FIGS. 11A, 11B, 11C, 11D show simplified web pages which may be sent by a database web interface. Only the forms which users would utilize to perform searches are shown. FIG. 11A shows the text search form used for manual search, security update, and “page analysis” actions. This form comprises a field F30 where the user can enter keywords to be searched, fields F31, F32 where the user can select an identifier and a version number for the network device, and a button F33 to click to trigger a search. The mapping table content (field F13) of the web page of FIG. 11A is as follows:

TABLE 2

| | | | OBJ Val. | |
|---|---|---|---|---|
| | ELT Selector | OBJ ID | Method | OBJ Val. |
| Object | (field F131) | (F132) | (F134) | (F133) |
| F30 | //*[name=form-keyword] | Keyword | device | Undefined |
| F31 | //*[name=form-device] | Device | device | Undefined |
| F32 | //*[name=form-version] | Version | device | Undefined |
| F33 | //*[name=form-search] | Click | Default | Null |

FIG. 12B shows a download search form used to perform a download action. This form comprises fields F34, F35 where the user can select an identifier and a version number for the network device, checkboxes F36, F37, F38 to select which type of download is to be performed, i.e. installation software, hot-fix software or security patch, and a button F39 to click to trigger a search. The mapping table content of the web page of FIG. 11B is as follows:

TABLE 3

| | | | OBJ Val. | |
|---|---|---|---|---|
| Object | ELT Selector | OBJ ID | method | OBJ Val. |
| F34 | //*[name=form-device] | device | device | Undefined |
| F35 | //*[name=form-version] | version | device | Undefined |
| F36 | //*[name=form-install] | Install | Default | Unchecked |
| F37 | //*[name=form-hotfix] | hotfix | Default | Unchecked |
| F38 | //*[name=form-security] | security | Default | Checked |
| F39 | //*[name=form-submit] | click | Default | Null |

FIG. 11C shows an authentication form related to FIG. 11B. The identification form comprises fields F40, F41 where the user can introduce his username and password and a button F42 for triggering authentication. The mapping table content of the web page of FIG. 11C is as follows:

TABLE 4

| | | | OBJ Val. | |
|---|---|---|---|---|
| Object | ELT Selector | OBJ ID | method | OBJ Val. |
| F40 | //*[name=form-username] | username | user | Undefined |
| F41 | //*[name=form-password] | password | user | Undefined |
| F42 | //*[name=form-login] | click | Default | Null |

FIG. 11D shows an alternative form comprising tabs for accessing to a simple search form, and advanced search form, and to a download form, the simple search form being selected and displayed. This form comprises a field F43 where the user can enter keywords to be searched, and a button F44 to click to trigger a search. The mapping table content of the web page of FIG. 11D is as follows:

TABLE 5

| | | | OBJ Val. | |
|---|---|---|---|---|
| Object | ELT Selector | OBJ ID | method | OBJ Val. |
| F43 | //*[name=form-keyword] | Keyword | device | Undefined |
| F44 | //*[name=form-search] | Click | Default | null |

Information contained in the mapping table is used by a function hereafter called “object function” which relies on the automation library AUTL to send instructions to browser CWB. This function is designed generically to interact with any database independently of the actual XHTML code thereof and may be utilized for a plurality of web interfaces, like those of FIGS. 11A-11D. The object function receives two parameters, namely the element selector and the object value. The object function contains a list of predefined tasks or methods for each element type. The type of an element is retrieved dynamically via the automation library AUTL based on the XHTML source code of that element in the page of a database SDB, once the element has been selected thanks to the element selector, thus the element type does not need to be passed as a parameter nor does it need to be defined in the mapping table. Having element selectors independent from the element types makes the mapping table more robust to code changes on a support database SDB, as indeed one can rely on attributes less likely to be changed to identify these elements, such as the name attribute used for form processing on the interface WI of the database SDB, that one would not change when updating a page design.

Examples of methods corresponding to object types are given in the following table:

TABLE 6

| ELT Type | Method |
|---|---|
| //input[@type=‘text’] | Assign object value to object value attribute |
| //select | Select the option which value attribute value |
| | matches the passed object value |
| //button | Click |
| //input[@type=‘submit’] | Click |
| //input[@type=‘checkbox’] | Click according to the passed object value |
| | which is the string “checked” or |
| | “unchecked” (e.g. if input is checked |
| | and the object value is unchecked then click, |
| | otherwise do nothing, and vice-versa if the |
| | input is unchecked) |

It should be noticed that the element selector is not equal to the element type in the above table 6. The object function is independent from the database web interface code: a call to object function is made with element selector, for example F33 “//*[name=form-search]”. Such a call selects an element in the web page of FIG. 11A: “<input type=“submit” name=“form-submit” value=“Search”/>”. The method which corresponds to the element type also corresponds to F33: “//input[@type=‘submit’]”.

When a mapping table F13, F15 is loaded, predefined tasks corresponding to each object value method are executed by module EVTM to retrieve the object value of its corresponding object identifier. The keywords are retrieved by parsing the web interface content, the user credential are retrieved by getting the user input, unless the object value of an object identifier is already provided to module EVTM before the element value method is called. This allows to provide features such as caching, or manual searches whereby object values are respectively re-used from results of previous actions provided by the user as a search is submitted.

When operating on a web page of a database SDB, the order by which elements are manipulated is taken into account, for example the keyword field is set prior to pressing the submit button. However it is not possible to reliably rely on the XHTML structure of the web page to determine this order because the disposition of elements in the code which might not follow the desired order of execution, for instance if the keyword field F30 appears after or before the submit button F33 in the source code due to CSS float:right property used (although not represented). If the elements are manipulated following the order of the web page code, a search could be submitted without keywords. Thus the order of execution follows the order of the mapping table entries.

Each of the action filters in an entry of the action profile table APRF comprises (field F16):
a filter identifier (Filter ID) which may be used by a device profile DPRF to provide parameters for the object function call associated with the identifier,
an event order associated with the filter and which dictates when the filter should be executed, and
a function call which is a call to a function which returns predefined values such as true and false depending whether a condition that the function is supposed to verify is satisfied or not.

Examples of action filters are given in the following table:

TABLE 7

| | Event Order | Function call |
|---|---|---|
| 1 | E5 | is_not_link?(Event Data) |
| 2 | E3 | is_page_final?(Event Data) |

The filter 1 corresponds to a typical scenario of a user not very familiar with a device and who inadvertently displays a web page while looking for another. The queried database SDB may return useful information regarding that web page, the user may not stay long enough on that web page for the query results to be displayed as he quickly navigates away from the web page accessed by mistake. To prevent querying the database unnecessarily, the filter 1 is associated with the event order E5 (triggered on DOM click) and the function “is_not_link?” which checks whether an element is a link (presence of href attribute) and returns true if it is not. Function “is not link?” takes as a parameter the event data E5 which is a copy of the clicked element.

Navigation menus enable users to browse the web interface of the network devices NDV. Depending on the complexity of the web interface, the navigation flow may be designed to have users browse through several intermediate pages before finally reaching a page where configuration options of the device may be found (hereafter referred to as final). An example navigation flow may be successively home, networking, vlan, interfaces, interface settings with home, networking, vlan, interfaces as intermediate pages offering only navigation options to other pages including the interface settings final page where options can be configured. To prevent querying the database SDB unnecessarily from intermediate pages, which contain information about other different pages, but may not contain content that is specific enough to produce pertinent queries and results, the filter 2 in table 7 is associated with the event order E3 (triggered when the HTTP body of a web page from a network device is received) and the function is_page_final? which returns true if the page is identified as final. If some network devices provide such limited functionalities that their web interface only contains final pages, defining the filter is_page_final? as an action filter would cause the filter to be unnecessarily executed every time a page is accessed on these devices. Accordingly, the filter may be defined as a device filter in device profiles associated with network devices which web interfaces do contain intermediate pages is more optimized.

FIG. 12 represents a sequence executed at step S37 (FIG. 6) of collecting the action data, for processing one entry of the mapping table (field F13). The execution of this sequence is repeated for all mapping table entries. The sequence of FIG. 12 comprises steps S70 to S76. First, the mapping table (Field F13) is loaded from the loaded action profile APRF into memory and each entry of the loaded table is read to determine the data to be obtained. At step S70, one entry of the mapping table is read. Then at step S71, the entries for the current action are reviewed in event table ET based on the mapping table entry object identifier F132 to determine if a matching object identifier can be found. If a matching object identifier is found, the object value associated with the matching object identifier in event table ET is assigned to the mapping table entry object value field F132 (step S72) and the sequence stops. If no object identifier is found at step S71, the object value method (field F133) is tested at step S73 to determine whether it is a method “device”. The reason for such verification is that the object value for mapping table entries with an object value method “device” is not assigned directly to the mapping table, but instead, handled separately in a different table called “query table” QUT. If the object value method is not “device” the object value method is called at step S74 and the value returned by that method is assigned to the object value at step S72. If the object value method is “device”, an additional verification is performed at step S75 to check whether a query table QUT was already created for the current action while reading a previous mapping table entry. If a query table was already created the sequence stops. If not, a query table QUT is created at step S76, which similarly to step S74 corresponds to calling the object value method of the mapping table entry with the difference that no value will be returned by the method and assigned to the object value. Instead, as explained earlier, values are stored in table QUT which will later be reviewed when performing the action. Verifying whether a query table was already created at step S75 while reading a previous mapping table entry prevents the query table from being unnecessarily created multiple times as the same query table applies to all the mapping table entries with a “device” object value method and only need to be created once.

Only mapping table entries for which no object value was reported via table ET and retrieved at step S72 are taken into consideration. This effectively gives the predefined object values F8 the property of overwriting the action mapping table F13 default behavior allowing the same mapping table to be used for a plurality of actions. For example, in the case of an “page analysis” action, if the device and version object identifiers of the network device NDV are not predefined, it means they have to be retrieved by module EVTM. In case of a “manual search” action, the device and version object identifiers will be set by the user, and thus become part of the predefined object values field F8. Therefore module EVTM does not need to perform some content analysis to retrieve these values.

FIG. 13 represents a sequence of execution of an action using browser CWB (an instance thereof). The sequence of FIG. 13 which is executed by module EVTM at step S39 (FIG. 6), comprises steps S80 to S85. At step S80, browser CWB accesses the web page corresponding to the ACT URI F12 of the action profile APRF loaded at step S30. Then at step S81, once the web page is received, a verification is made to see if an HTTP redirect or other forms of redirects to the authentication web page defined by field F14 occurred. This redirect occurs when accessing the action URI page and can be detected by controlled browser CWB. Step S81 thus allows module EVTM to detect if a user authentication is required. If a user authentication is not required (URI of page loaded by browser CWB after redirection does not match the Auth URI F14) the execution of the sequence continues at step S85, else steps S82 and S83 are performed.

At step S82, the page corresponding to authentication URI is loaded and user credentials are entered. This involves the same steps as for performing an action except that the Auth. mapping table F15 is used instead of the action mapping table F13 and that the steps S80 to S84 are not needed anymore because browser CWB is already at the Auth URI page. In that case the Auth URI page is manipulated by the object function at step S85. In order to receive the credentials, module EVTM would notify component BPI to prompt user for credentials, and wait until such credentials are provided by the user and then returned by component BPI. At step S83, after performing the authentication, another URI verification is made to see if browser CWB was redirected to the action URI F12. This test is performed in case a redirection to the Action URI does not occur after performing the authentication. This redirection might not occur depending on the database navigation flow, but is used for performing an action.

A navigation flow to access a particular page in a database SDB web interface may be:

a—user connects to the database home page,
b—if the user is not authenticated, a redirection is made to the authenticatation page, which corresponds in the present case to the authentication URI,
c—the user authenticates himself,
d—a redirection is made to the database home page, regardless of the page accessed at step a,
e—the user then clicks on a search section,
f—from the search section, the user can navigate to an advanced search page which corresponds in the present case to the action page.

To access the action page, an unauthenticated user goes through all the steps (a to f) whereas browser CWB can skip step e thanks to step S84 which brings it directly to action page after authentication. To access the action page, an authenticated user would go through steps a, e and f whereas browser CWB only need step f (step S80). Thus browser CWB can reach directly the action page before or after authentication, and reduces the number of steps performed by browser CWB, which reduces the action execution time and speeds up the display of results to users. Additionally, it offers a simplified and more standardized way of accessing action pages, as each action does not require more than two URIs, regardless of the steps a user would normally follow, which facilitates the creation of actions.

If authentication is performed at step S82 and credentials need to be provided by the user, the corresponding instance of module EVTM enter a wait loop until such credentials are provided by the user. If the user does not provide the credentials right away and keeps operating on network devices, other instances of module EVTM may be started (page analysis on other pages, security updates etc. . . . ) which will all hang the same way at step S82 if authentication for these actions is also required. Before detecting that user authentication is required at S82 (part of step S39), a browser tab is opened inside browser CWB at step S38. That browser tab remains opened until module EVTM receives the credentials and can complete the action, consuming resources in the meantime. Additionally, the corresponding instances of event reporter ERP may remain active until module EVTM can notify them to stop after performing the action, consuming additional resources. Moreover, actions that are processed only if previous actions are complete would not be executed before the previous actions waiting for authentication, thus affecting the user experience.

To address these issues, a user authentication may be performed while starting component BPI, and event reporters are triggered only when the authentication is successful, which triggers the reporting of events and the processing of actions. After successfully authenticating the user when starting BPI, credentials may be cached while component BPI remains active. Accordingly, instead of prompting the user for credentials at step S82, these would be served directly from cache. Steps S81 to S84 allow detecting the need for authentication and transparently handling it using previously cached credentials, which might be needed from time to time as the user session created following a successful authentication when starting component BPI expires.

At step S84, the action URI page is loaded if the browser CWB was redirected to a different page following the first action URI page access at step S80 or after the authentication at step S82. Then at step S85, calls to object functions using the object selector F131 and the object value method F133 are performed for each entry of the action mapping table F13. To this purpose, the mapping table is read from the top of the table and following the table order to ensure that selectable objects of the database web interface are manipulated in the order that they should (for instance providing a keyword before submitting a search). Performing the action based on the mere mapping table applies to all the actions (e.g. manual search, security update, . . . ) except to actions for which a query table QUT was created during step S76 (e.g. page analysis), in which case the way the action is performed differs slightly. When a query table QUT is created at step S76, the process of going through the action mapping table F13 and calling the object function for each mapping table entry is repeated for every query in table QUT. For every query, each mapping table entry with a “device” method and an unassigned object value has its object value set to the object value of the corresponding object identifier from the query.

The selectable objects in an action URI page comprise values that users must choose from. Accordingly these values are collected and displayed in the user interface of component BPI in order to allow the user to perform manual searches. In a web page, it is common to have a selectable object depending on another one, so that choosing a value from one element changes the values of the others. For instance in FIG. 11A, when a device option (field F31) is selected, selectable version options (field F32) are updated accordingly through a call for example in JavaScript, to an update version function.

FIG. 14 shows an example of value tree built for selectable objects in fields F31 and F32 with values from F32 depending on values selected from F31. This tree comprises a list L1 of values available for options of the field F31, and lists L2, L3, L4 of values available for options of the field F32, each of the list L2, L3, L4 corresponding to an option in the list L1. List L1 is a list of network devices. List L2 is a list of available versions of devices “router1000” and “router2000” in list L1. List L3 corresponds to available versions of devices “firewall500” and “firewall700” in list L1, and list L4 corresponds to available versions of “switch100” in list L1.

The value tree is created by browser CWB by selecting each value from field F31 one after the other and associating for each value from field F31 the values updated into field F32. In order to avoid delaying the execution of actions as the value tree is used as part of the action execution of the device object value method, value trees for action URI pages are created when starting component BPI before registering event reporters ERP, updated periodically by a separate process to ensure that changes to the web pages of the databases SDB are taken into account, and stored in memory with their corresponding action URI to allow instances of module EVTM reading from them when needed.

Knowing the dependency between selectable elements allows to determine how creating the value tree. For instance, if instead of considering field F32 being dependent on field F31, browser CWB was considering that field F31 being dependent on field F32, the value tree structure would change with list L1 comprising values from lists L2, L3, or L4 depending on which of these values would be comprised in field F32 by default, and lists L2, L3, and L4 merged into one single list comprising values from list L1. When iterating through field F32 values, browser CWB would always read the same values from field F31 which does not change when a value from field F32 is selected.

Determining the dependency between selectable elements is achieved based on the mapping table order by placing selectable elements which affect values from other selectable elements right above in the table. For instance the entry corresponding to field F31 is placed above the entry corresponding to field F32 in mapping table represented by Table 2. This method may be extended to more than two selectable elements. For instance if after selecting a version, another selectable element was updated to specify the level of hotfix for a particular version, another entry in the mapping table could be added below the entry corresponding to field F32 for that other selectable element.

The benefits of creating value trees for action URI pages are numerous. First, as explained earlier, in order to offer users the ability to perform manual searches, selectable elements values are displayed to users via the user interface of component BPI. One solution would be to recreate the functions used in the pages of databases SDB to update selectable elements of database SBD inside the component BPI user interface, and have the BPI query SDB, via a specific function call to module EVTM fetching and returning the values using the controlled browser CWB, to update the selectable elements in component BPI every time a value is chosen by users. Another solution would be to have page selectable element values of databases SBD predefined statically in action profiles. However having selected selectable elements values in component BPI, gathered from the cached value trees in memory would offer a faster user experience than the first solution because accessing memory is faster than querying a database SDB but also save some requests to and resources on the queried database SDB to process those requests, and would facilitate the maintenance of system SISS over the second solution when pages of databases SDB are updated as value trees would be updated periodically whereas updating action profiles would involve updating the software of system SISS. The second benefit is about using the value tree to facilitate the extraction of relevant content as part of the device object value method. Finally, by periodically querying databases SDB to keep the value trees up to date, browser CWB provides a keep alive mechanism to prevent user session from timing out and speeds up the execution of actions by saving module EVTM from having to perform steps S81 to S84.

The value tree may be used to facilitate the extraction of content when the use of patterns as described earlier is not suitable. Let us consider several network devices returning the values for the device and version object identifiers as free text inside a description HTML meta tag, such as the examples given below:

```
  <meta name=″description″ content=″Admin interface for
switch100, version v3.4″ />
  <meta name=″description″ content=″firewall700 web interface -
  v10.8″ />
```

Using the patterns given in Annex II would not enable extracting only the object values because the rest of the text would also be extracted. Also defining a new pattern applying to both meta tags would not be possible due to the different positioning of object values in each case. The value tree allows solving these problems by identifying the object values based on the content of the support database. For instance, based on the value tree of FIG. 14, the first description meta tag content would first be parsed for the values of list L1, attempting to find values “router1000”, “router2000”, “firewall500”, and “firewall700”, before finding value “switch100”. According to the value tree structure, the meta tag would then be parsed for the values of list L4, attempting to find value “v3.3” before finding value “v3.4”. Please note how the tree structure saves an unnecessary search of values comprised in lists L2 and L3 once the L1 value linked with L4 has been identified. Similarly, the second description meta tag would be parsed using the values of list L1, finding “firewall700”, then parsed using the values of list L2, finding value “v10.8”, and saving an unnecessary search of values comprised in lists L3 and L4.

The use of the value tree may be implemented using the content extraction patterns table, as part of the device object value method, for instance by setting the object identifier locator to a predefined value such as “value-tree” to indicate that the use of the value tree associated with the loaded action profile is required, as shown in the following table:

TABLE 8

| | OBJ ID | OBJ value | |
|---|---|---|---|
| Selector | locator | locator | Type |
| //meta[@name=“description”] | value-tree | {content} | M |

The selector and object value locator would enable extracting the content attribute value from the description meta tag on which to perform the search of values, thus limiting the scope of such search to a particular attribute instead of the entire web page and consequently optimizing the search. Then the process described above whereby values from the tree are search for following the tree structure would be applied to the content extracted using the selector and the object value locator, allowing to extract one or more object identifier and object value depending on the structure of the value tree.

A step S85, once the element values have been collected or the query table created following steps described in FIG. 12, function calls are performed following the mapping table entries order while providing the object selector and the object value from each entry. In the example of FIG. 11A these function calls may be as follows:

objectFunction(′//*[name=form-keyword]′,obj value)
objectFunction(′//*[name=form-device]′, obj value)
objectFunction(′//*[name=form-version]′,obj value)
objectFunction(′//*[name=form-search]′,null)

The device profiles DPRF are provided to offer support for a plurality of network devices NDV1, NDV2, NDV3. Acquisition of another company which offers different products or a major change in the software architecture can make a manufacturer have network devices with significant differences in their code, hence the use of profiles to define how interacting with these different devices.

An example of table DPRF is given in Annex II. In this example, table DPRF comprises four device profiles 1-4. In this table, values in fields F20, F21, and F22 are represented as regular expression patterns although other string definition languages may be used. In the profile 1, field F20 (predefined OBJ ID) is “device” and the associated OBJ Value is a pattern “router.*”, which means it will match any device (OBJ ID) which device name (object value) starts with “router”. Based on the examples given in FIG. 14, this may be “router1000” or “router2000”. Field F21 (Profile identification patterns) contains two identification patterns. The first pattern is used to detect Cookie HTTP headers sent by the client (here browser WBR) which match the “.*myvendor-router.” pattern. The first pattern contains leading and trailing wildcards “.*” as the position of a particular cookie within the Cookie HTTP header and its value may vary. The second pattern is used to detect set-Cookie HTTP headers received from the network device which match “myvendor-router.” pattern. Once again the pattern contains a trailing wildcard because the set-Cookie value, path and other arguments may vary. These patterns may be used to detect devices using form-based authentication with session cookies. The first request send by browser WBR to the network device is served by an authentication form. After posting that form with correct credentials, browser WBR is served a session cookie, when the network device will be detected for the first time thanks to the second pattern. On subsequent requests, browser WBR provides the session cookie and the device is detected based on the first pattern. Field F23 contains a reference to an event to be matched (event E1) and to a function to be called (“is_help_section?( )”) when a request is sent by browser WBR. This function takes two arguments “$URI” and “$help_section_path”. The argument “$URI” corresponds to the value gathered from the current ET table entry URI field F5. The argument “$help_section_path” is a predefined path value, such as /help-section/. Such function may be used to filter out requests to help sections if the predefined help section path value is found within the field F5 of current EVT table. The action filters parameters (field F24) provide the function “is_page_final( )” contained in the “page analysis” action profile with the Xpath to the navigation menu.

Profile 2 in Annex II is similar to profile 1 except that both predefined OBJ ID/OBJ Values and device identification patterns use a more specific device pattern. Based on FIG. 14, this device profile would only match firewall700 and not “firewall500”. This may be used to exclude a particular device (“firewall500”), for instance if the manufacturer decides to discontinue support for it.

Profile 3 in Annex II contains significant differences in its device identification patterns. The first pattern operates on the event order E2, which corresponds to receiving HTTP headers from the network device. Instead of looking for Set-Cookie headers, this pattern is an attempt to match a particular realm value, here “myvendor-switch100”, from a HTTP basic authentication header served by the network device. The second pattern is an attempt to match a “device” HTML meta tag containing the “switch100” content. The reason for not checking client request HTTP headers with the second pattern is that following a successful authentication, the client sends an Authorization header which only contains the generic “Basic” word associated with a variable string representing encoded credentials, and is therefore not suitable for detection purpose as a pattern would match any network device using basic HTTP Basic authentication. These patterns may for instance be used to offer support to legacy devices (because HTTP basic authentication is less commonly used nowadays than cookie-based authentication), these legacy devices being still supported by a manufacturer, for which the manufacturer may decide, as a workaround for not being able to detect the device based on specific client request HTTP headers, to add static content into the network device web interface (the HTML meta tag). This addition may involve less code change than to change the authentication mechanism of the network device. Field F23 shows that the same action filters may not be used on all network devices, for instance the filter to filter out help section pages used in profiles 1 and 2 may not be required if the network device web interface does not have a dedicated help section, which may be the case with more basic network devices such as switches.

Field F20 of profile 4 contains a wildcard “device” as OBJ value. This means the object identifier and object value would match any device, which may be used to provide users with the ability to perform manual searches for any devices via the web interface of component BPI. Despite an action profile APRF being available for the manual search, loading a device profile DPRF at step S30 is still performed to complete the sequence of FIG. 6. In order to limit the scope of this device profile to manual searches only, the device profile contains a device filter (field F23) based on the event order E6 associated with manual searches. The filter makes a call to the function “always_true( )” which as its name indicates always returns a true value, allowing the device filter conditions to be met only if the event E6 is encountered, and fail otherwise, thus ensuring this device profile may be utilized only for manual searches. Because this profile is associated with a manual search, it does not require any device identification or content extraction patterns (fields F21, F22).

Now content extraction patterns (field F22) will be described. These patterns apply to page analysis action with the purpose of collecting the object values to assign to the object identifiers specified in a mapping table (Fields F13, F15). The number and content of the queries are also established. This collection uses a content table CNT which is a simplified representation of the content of the network device web interface. This representation combines object identifiers identified in the HTML code of the device web interface along with their corresponding object values. A query table QUT stores the result of an analysis on the content table CNT. Table QUT creates queries by combining relevant entries from table CNT. Some examples of content extraction patterns (F22) are given in Annex II.

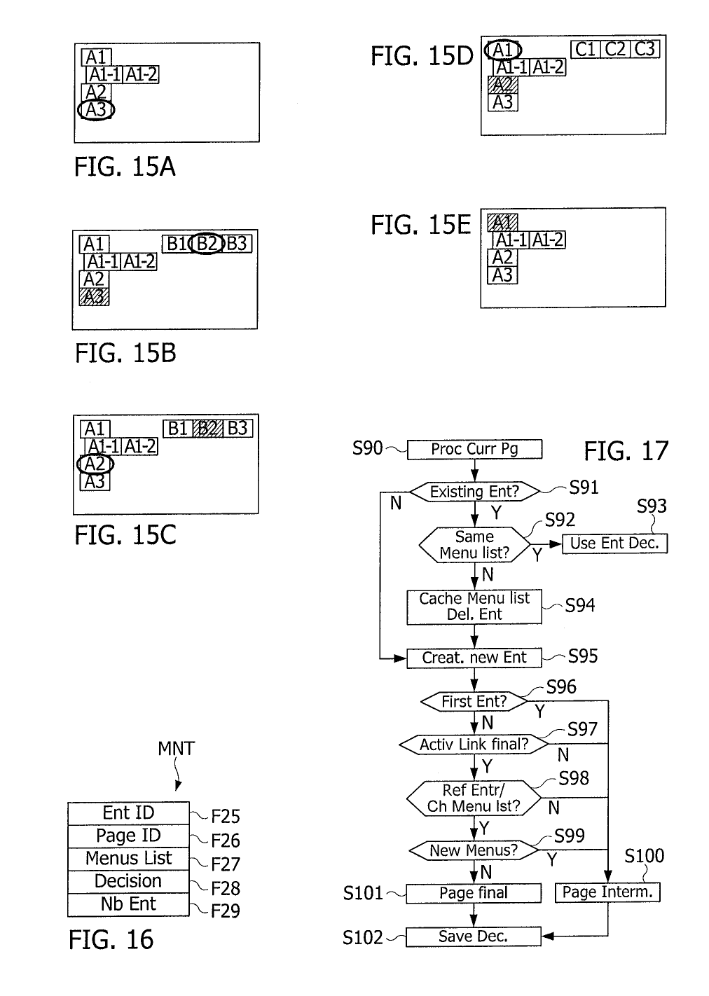

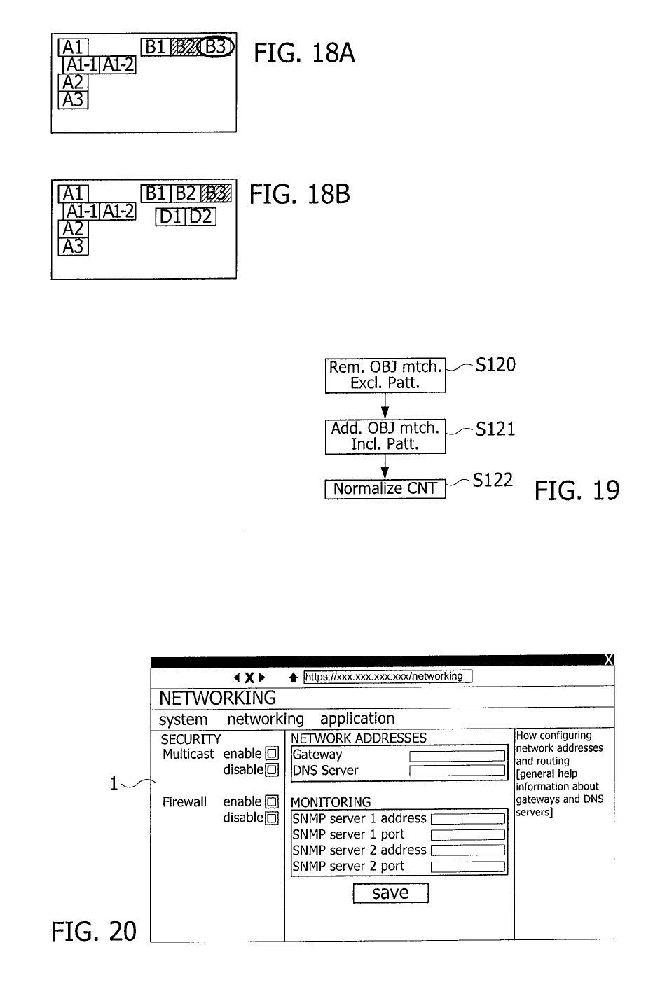

FIGS. 15A to 15E and 18A, 18B show several simplified web pages illustrating a navigation flow on a web interface of a network device NDV, composed of a plurality of navigation menus. The circled items in FIGS. 15A-15D and 18A represent a clicked link leading to a next web page (next figure). The navigation order follows the numbering of figures. Hatched items represent the web page active link, that is the link that was clicked to get that page. The source code corresponding to the various navigation menus is provided in source codes 1-4 in Annex III. A link is said final if its corresponding element in the source code does not have any child link elements, for instance. In the source code 1, the links A2, A3, A1-1, and A1-2 are final, only A1 is not final because it has A1-1 and A1-2 as child links. A page is said final if it corresponds to the end of a navigation flow, otherwise it is said intermediate.

In a first example, the analysis of the page of FIG. 15B would give A3 as a final link because it does not have any child nodes. By relying solely on this observation, one may conclude that the corresponding page is final. However the above approach does not take into consideration the fact that the navigation links for a same navigation flow may be spread across several separate menus, as it can be, with some menus only displayed when a user reach a page at a more advanced stage in the navigation. For instance by comparing the page of FIG. 15B (source code 2) with the previous page (FIG. 15A), one can see that a new menu B1-B2-B3 appears in page of FIG. 15B and that clicking on A3 provide users with that new menu to choose from, meaning that the end of the navigation flow is not reached, and that only after clicking on this new menu it may be determined whether the page is final. Thus a first condition for a page to be considered as final is for its active links to be final, and a second condition is for the page not to contain any new menus when navigating from another page.

According to another method, a menu table keeping records of the visited page and the encountered menus is created. Then by comparing the entries of this table, it is possible to detect the presence of new menus and make sure that only when active links belong to new menus the page is marked as final. The issue is that HTML does not provide a mechanism to indicate which page was previously requested when inspecting the HTML code of a particular page. Therefore finding the appropriate table entry to use for the comparison is not that straightforward. HTTP provides a referrer header which indicates it and similarly a web server could insert a referrer header value into the HTML source code, for instance using a custom <meta> element. However web pages of network device web interfaces may be accessed directly, for instance by selecting the page URL from the browser cache, in which case none of this would be useful. The proposed method offers a solution to that problem.

As shown in FIG. 16, the menu table MNT contains the following fields:
“Entry ID” F25 identifies each entry of the menu table; this field may be omitted as table entries can be referred to simply using an identifier;
“Page ID” F26 identifies a page on the device web interface; it may be a URL path if the web interface was designed with search friendly URLs (SFUs) such as “/networking/vlan” or the combination of the URL path and query such as “/index?category=1&subcategory=2”;
“Menus List” F27 records all the menus identified in a particular page;
“Decision” F28 contains the result of the process to determine whether the page is final, that is saved in the corresponding entry, so that it can be re-used multiple times while saving some of the analysis;
“Nb Entries” F29 corresponds to the number of entries present in the table at the time the decision was saved.

When checking an existing entry, if the content of field “Nb Entries” corresponds to the number of entries in the table, that means that the user has not visited other pages (there is a 1-1 relationship between number of visited page and entries. Assuming menus found in fields of table MNT and in the page are the same, this means there is no new information in the menu table and analysis will produce the same decision. Accordingly we can simply reuse the decision recorded in field “decision” which saves doing a new analysis every time the same page is requested. In addition, if the web interface of a This comes handy for changing decisions related to pages accessed directly (if it was just based on menu comparison, decision would change only if the web interface was changed). For instance source code 3 and source code 4 (Annex III) show a menu using the same identifier “menu-top-2” while having different links (respectively C1, C2 and D1, D2) because displayed at two different stages of the navigation (respectively FIGS. 15D and 15E). However there would be no point in having on the same page two separate menus with exactly the same links as it would only confuse users. Accordingly for the purpose of creating the menus list, menus are identified based on the links they contain.

FIG. 17 is a flowchart of a sequence for analyzing menus which may be performed at step S32, for instance as part of the action filter function “is_page_final”, in order to determine relations between them and detect final pages, that is pages worth to be used for executing an action. This sequence also provides a caching mechanism to memorize decisions and a correction feature to update saved decisions when the menus of a web interface change. The menu analyzing sequence comprises steps S90 to S102. At step S90, the current page is processed from which the page identifier “Page ID” and the menu list “Menus List” are retrieved. At step S91, an existing entry with the same identifier “Page ID” as the one retrieved at step S90 is search for in the menu table. If none is found, the step S95 is executed, otherwise step S92 is executed. At step S92, it is checked whether the menu list in the existing entry (step S91) and the current page (step S90) match, in which case at step S93 the existing entry decision “decision” in menu table is reused. If the menu list differs between the existing entry and the current page, a new decision is made, and the existing entry is deleted from the table at step S94, so that a new entry can be created at step S95 to store the new decision (note: instead of deleting/recreating an entry in the menu table, the entry could be updated). At step S95, whether no entry could be found at step S91 or an existing entry was deleted at S94, a new entry is created with the current page identifier, and the menus list retrieved. At step S96, it is checked whether it is the first entry in the table (i.e. the table was empty before), which corresponds to getting to the home page likely to hold generic information and not be specific enough for the purpose of performing the action. If it is the first entry, the page is flagged as “intermediate” at step S100, otherwise the active link is identified at step S97 and checked whether it is a final link. If this link is not final, there is no need for doing further analysis as like explained earlier, one of the conditions for a page to be final is for its active link to be final, and it is decided to mark the page as intermediate (step S100). If the link is final, further analysis is performed from step S98.

At step S98, a referring entry, that is the entry corresponding to the which clicked link led to the current page is searched for in table MNT. The referring entry is the earliest menu table entry which contains the menu corresponding to the current page active link, for which none of the links are active. If no entry can be found in the menu table, it means that the page was accessed directly. Therefore, the page is flagged as final at step S101 and as one can assume that the user was either provided the link to the current page by an external source (database articles, support team . . . ) for which he already received relevant support information, or that he wrote down the link during a previous browsing session to the page in which case, if the page was final, he would have already received the support information from component BPI (here not providing information is preferred over providing unnecessary or irrelevant information, maybe other manufacturers would decide that by default pages should be inspected).

At step S99, the menu list from the referring entry identified at step S98 and the new entry created at step S95 are compared to determine whether the new entry contains new menus. If one or more menus appearing in new entry are not present in the referring entry it means these menus are new. As explained earlier, the second condition for a page to be considered final is for the page not to contain any new menus. Accordingly, the page is marked as intermediate at step S100. If no new menu is found in the new entry, the page is marked as final at step S101.

It should be noted that whenever a decision is made to mark the page as intermediate of final respectively at steps S100 and S101, the decision is memorized at step S102 so that it can be re-used at step S93 during a future analysis.

Below are tables representing analysis of pages shown in FIGS. 15A-15E and 18A, 18B, which all correspond to the same device and version options, so the same table will be used throughout. Before the page of FIG. 15A is analyzed, the menu table is empty.

In the page of FIG. 15A, the current page is retrieved (step S90), no existing entry is found (step S91). A menus list is retrieved from the current page which contains a menu A (A1, A1-1, A1-2, A2, A3). No existing entry is found at step S91, so a new entry is created at step S95. This entry is the first entry (step S96), the page is marked as intermediate at step S100 and the decision is saved at step S102. Thus the content of table MNT is as follows:

TABLE 9

| Entry ID | Page ID | Menu list | Decision | Entry NB |
|---|---|---|---|---|
| ENTRY1 | Home | A | Intermediate | 1 |

Then the page of FIG. 15B is retrieved and analyzed (step S90). A menu list is retrieved from the current page which contains menus A (A1, A1-1, A1-2, A2, A3) and B (B1, B2, B3). No existing entry is found at step S91. A new entry is thus created at step S95 (the second one). The active link A3 is detected final at step S97 and the referring entry ENTRY1 is found at step S98. However a new menu B (B1, B2, B3) appeared (step S99), so the page is flagged as intermediate at step S100 and the decision is saved at step S102. Thus the content of the menu table is now as follows:

TABLE 10

| Entry Id | Page | Menu list | Decision | Entry Nb |
|---|---|---|---|---|
| ENTRY1 | Home | A | Intermediate | 1 |
| ENTRY2 | A3 | A, B | Intermediate | 2 |

Then the page of FIG. 15C is retrieved and analyzed (step S90). No existing entry is found at step S91. A new entry is thus created at step S95 (the third one). The active link A3 is detected final at step S97 and the referring entry ENTRY2 is found at step S98. The page does not comprise any new menu (step S99), so the page is flagged as final at step S102 and the decision is saved at step S102. Thus the content of the menu table is now as follows:

TABLE 11

| Entry Id | Page | Menu list | Decision | Entry Nb |
|---|---|---|---|---|
| ENTRY1 | Home | A | Intermediate | 1 |
| ENTRY2 | A3 | A, B | Intermediate | 2 |
| ENTRY3 | B2 | A, B | Final | 3 |

Then the page of FIG. 15D is retrieved and analyzed. This page is the same as the one of FIG. 15B excepting a menu C (C1, C2, C3) has replaced menu B. No existing entry is found in the menu table at step S91. Thus a new entry is inserted into the menu table (the fourth one) at step S95. The active link A2 is final at step S97, the referring entry ENTRY1 is found at step S98. However a new menu C is present (step S99), so the current page is flagged as intermediate at step S100 and the decision is saved at step S102. Thus the content of the menu table is now as follows:

TABLE 12

| Entry Id | Page | Menu list | Decision | Entry Nb |
|---|---|---|---|---|
| ENTRY1 | Home | A | Intermediate | 1 |
| ENTRY2 | A3 | A, B | Intermediate | 2 |
| ENTRY3 | B2 | A, B | Final | 3 |
| ENTRY4 | A2 | A, C | Intermediate | 4 |

Then the page of FIG. 15E is retrieved and analyzed. This page is the same as the one of FIG. 15A. No existing entry is found in the menu table at step S91. Thus a new entry is inserted into the menu table (the fifth one) at step S95. The active link A1 is not final at step S97, so the current page is flagged as intermediate at step S100 and the decision is saved at step S102. Thus the content of the menu table is now as follows:

TABLE 13

| Entry Id | Page | Menu list | Decision | Entry Nb |
|---|---|---|---|---|
| ENTRY1 | Home | A | Intermediate | 1 |
| ENTRY2 | A3 | A, B | Intermediate | 2 |
| ENTRY3 | B2 | A, B | Final | 3 |
| ENTRY4 | A2 | A, C | Intermediate | 4 |
| ENTRY5 | A1 | A | Intermediate | 5 |

The page of FIG. 18A is retrieved and analyzed. ENTRY3 is found as an existing entry in the menu table at step S9. ENTRY3 has the same menu list at step S92. Thus the decision “final” is reused at step S93. Therefore the content of the menu table remains unchanged.

Then the page of FIG. 18B is retrieved and analyzed. ENTRY3 is found as an existing entry in the menu table at step S92. However ENTRY3 has a different menu list (step S92), as ENTRY3 has menus A and B whereas the current page has menus A, B, D (D1, D2). Thus a new entry is inserted in the table menu at step S95 (the sixth). The active link B3 is final (step S96). However compared with ENTRY3, a new menu D appeared (Step S99), so the current page is flagged as intermediate at step S100 and the decision is saved at step S102. Thus the content of the menu table is now as follows:

TABLE 14

| Entry Id | Page | Menu list | Decision | Entry Nb |
|---|---|---|---|---|
| ENTRY1 | Home | A | Intermediate | 1 |
| ENTRY2 | A3 | A, B | Intermediate | 2 |
| ENTRY3 | B2 | A, B | Final | 3 |
| ENTRY4 | A2 | A, C | Intermediate | 4 |
| ENTRY5 | A1 | A | Intermediate | 5 |
| ENTRY6 | B2 | A, B, D | Intermediate | 6 |

Now content extraction patterns (field F22) will be described. These patterns apply to page analysis action with the purpose of collecting the object values to assign to the object identifiers specified in a mapping table (Fields F13, F15). The number and content of the queries are also established. This collection uses a content table CNT which is a simplified representation of the content of the network device web interface. This representation combines element tags identified in the HTML code of the device web interface along with their corresponding element values. A query table QUT stores the result of an analysis on the content table CNT. Table QUT creates queries by combining relevant entries from table CNT. The source code of network device pages to be analyzed is collected from browser WBR by instances of reporter ERP “page received” and inserted into table ET inside the event data field F7, during the events E3 or E4. Corresponding instances of module EVTM then collect the source code from table ET and delegate it processing to parser XHP which then returns the results to module EVTM instances. Thus instances of module EVTM do not operate directly on browser WBR DOM which could degrade user experience if for the purpose of analysis some content needs to be removed, but merely on a copy of page source code or DOM.

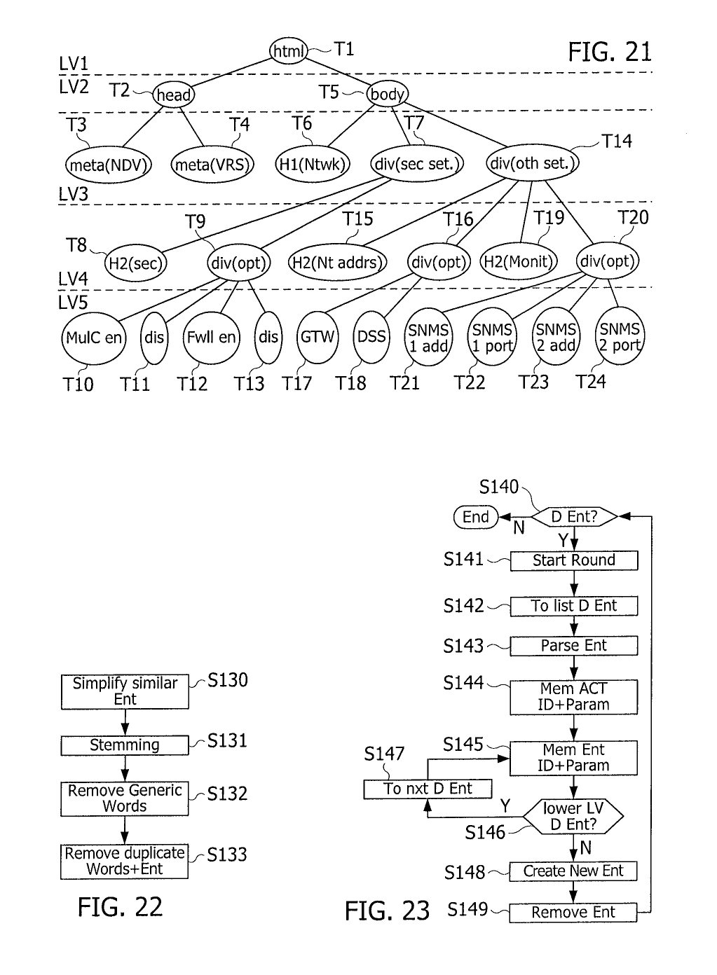

FIG. 19 is a flowchart of a sequence provided for filling the content table CNT (performed at step S76 in FIG. 13). The following explanation is based on the sample web page of FIG. 20 and its corresponding source code 5 (Annex III). This sequence comprises steps S120 to S122. At step S120, the elements matching a pattern in an exclusion list are removed. This step is used to exclude unwanted content from the analysis. Such unwanted content comprises for example navigation menus which contain information about other pages or help sections displaying information structured in paragraphs which is less favorable to the search for keywords. Instead of removing it, unwanted content could be discarded during the inclusion process at step S121, although removing content here facilitates the exclusion process when certain types of elements are used in both wanted and unwanted content. An example of exclusion pattern list is given in Annex II. Each entry of the inclusion list comprises a selector defined as an Xpath string which identifies elements in a page.

In annex II, “//ul” is used to remove menus, “//div[@id=“help”]” is used to remove the “help” sections, whereas “lip” removes “p” elements which represent paragraphs. The selectors must be predefined in order to match the web interface although some selectors may be commonly suitable for any web interface environment like “ul” or “p”. The source code of the sample page of FIG. 20 after removing the content matching the exclusion list (step 120) is available in annex III, Source Code 6. As explained earlier, removing the content during step S120 may facilitate the later inclusion process. For instance, assuming “h2” elements had to be included, one “h2” element would be found inside the “help” section. In order to discard that element, one would need to review its parent nodes and verify each node against the exclusion patterns. This process would have to be repeated for every element to be included. By removing the “help” section during the exclusion process, the “h2” elements it contains would not appear in the later inclusion process, thus saving further analysis on its parent nodes. Therefore the proposed solution of removing the unwanted content during the exclusion process reduces the amount of processing during the inclusion process and reduces the time to analyze the web interface content and subsequently display results to users.

At step S121, the elements from Source Code 6 matching a pattern in an inclusion list are added to the content table CNT. An example of inclusion list is given in Annex II. Each entry of the inclusion list comprises a selector as an Xpath string, an object identifier locator, an object value locator and a type. The selectors in such an inclusion list identifies elements in a page, whereas the object identifier locator and the object value locator indicate which part of the selected elements should be used respectively as the object identifier and value parameters. These locators may refer to the name of an attribute, to a method used by an XHTML parser returning a value, or be assigned a default value. Finally the type indicates whether the content type is metadata “M” or data “D”, as the content from these two types will be treated differently when creating a query.

In the example of Annex II, the first entry in the inclusion list selects “meta” elements for which it uses the value of the “content” and “name” attributes respectively for the object identifier and value parameters. Using such syntax enables mapping a plurality of source code elements with a plurality of entries in the mapping table via the use of a single declaration. The source code concerned by this first entry in source code 6 is the following:

<meta name″=″device″ content=″router1000″/>
<meta name=″version″ content=″1.2.3″/>

The elements selected by the first entry of the inclusion list are as object identifiers and corresponding object values “device” corresponding to “router1000”, and “version” corresponding to “1.2.3”.

It may be required to rewrite the code of the network device web interface pages so that declaration of HTML meta tags matches the declaration of the mapping table. However it is anticipated that given how this facilitates the extraction of content from the web interface of the network devices NDV that manufacturers might indeed opt for this method.

In the example of Annex II, the second entry in the inclusion list selects any “h1”, “h2” or “label” elements present in the source code for which it assigns respectively the default “keyword” value and the element inner text respectively to the object identifier and value parameters. Using such a syntax enables creating all the keywords entries for the whole document with one single declaration.

In order to fill the content table CNT, the source code 6 (Annex III) obtained after step S121 is parsed from the page root (html) to the last element. When several sibling nodes are found, each node is parsed recursively for all child nodes it contains before moving to the next sibling node which preserves the order of elements as declared in the source code in table CNT. Tree nodes that match the inclusion list are added to table CNT following their numbering. Each entry comprises the object identifier, object value, and type collected as above-explained, based on the inclusion list but also the element level in the document.

FIG. 21 is a tree diagram representing the result of the parsing of source code 6 corresponding to the web page of FIG. 20 after the exclusion process performed during step S120. This tree diagram comprises nodes numbered from T1 to T24. This numbering follows the order of the parsing as described above. The nodes T1-T24 are distributed in five levels LV1, LV2, LV3, LV4, LV5. For instance “head” T2 and “body” T5 which are in the same level LV2 are sibling nodes. The content table CNT resulting from step S121 applied to the source code 6 is given in the following table:

TABLE 15

| Entry | | | | | |
|---|---|---|---|---|---|
| N° | Level | ELT N° | OBJ ID | OBJ Val | Type |
| 1 | LV3 | T3 | device | router1000 | M |
| 2 | LV3 | T4 | version | 1.2.3 | M |
| 3 | LV3 | T6 | keyword | Networking | D |
| 4 | LV4 | T8 | keyword | Security | D |
| 5 | LV5 | T10 | keyword | multicast enable | D |
| 6 | LV5 | T11 | keyword | disable | D |
| 7 | LV5 | T12 | keyword | firewall enable | D |
| 8 | LV6 | T13 | keyword | disable | D |
| 9 | LV4 | T15 | keyword | Network Addresses | D |
| 10 | LV5 | T17 | keyword | gateway | D |
| 11 | LV5 | T18 | keyword | DNS server | D |
| 12 | LV4 | T19 | keyword | Monitoring | D |
| 13 | LV5 | T20 | keyword | SNMPv2 server 1 address | D |
| 14 | LV5 | T21 | keyword | SNMPv2 server 1 port | D |
| 15 | LV5 | T23 | keyword | SNMPv2 server 2 address | D |
| 16 | LV5 | T24 | keyword | SNMPv2 server 2 port | D |

As “head” T2 appears before “body” T5 in the document, its child nodes “meta” T3 and T4 are parsed and added in table CNT before “body” T5 child nodes such as T6 or T8 to preserve the order of elements in source code inside table CNT. The content analysis preserves the order of elements in the source code inside the table CNT so that the hierarchy of table CNT may be later used to combine entries together.

The web interfaces are designed to be meaningful to users and not necessarily optimized for the creation of queries. Thus at step S122, the content table CNT is normalized. Performing such processing on table CNT itself greatly facilitates the normalization process over any similar tasks performed on the database side as indeed the database would only receive separate queries and have no visibility about redundancies and similarities between these queries, and would require caching those queries to compare them, delaying the processing of each query until all queries would be cached.

FIG. 22 is a flowchart of a normalization sequence showing how the content table CNT is normalized at step S122. Normalization tasks are arranged in a more to less specific manner so that one task does not jeopardize the execution of the next one. For instance a cleanup task is performed last because it may otherwise prevent other tasks from being successfully completed, but also because these other tasks may highlight new situations suitable for cleanup. The normalization sequence comprises steps S130 to S133. At step S130, related configuration entries are simplified. The web interfaces may display several similar configuration entries such as entries 13, 14, 15 and 16 (in table 15) for configuring multiple SNMP servers. For differentiation purposes these entries contain numerical IDs (e.g. “SNMP server 1 address”, “SNMP server 2 address”) and are therefore different from a string comparison standpoint. However for the matter of querying a database, they relate to the same question: “is there something wrong regarding the DNS servers configuration?”. Accordingly only one of these two entries should be used for the query. However only removing duplicate terms from these two entries would leaves “1” and “2”. Systematically removing numerical values would risk to alter legitimate (alpha-)numerical terms such as “SNMPv2” becoming “SNMPv”. Thus removing duplicate terms and numbering is performed by recursive and differential comparison on level table entries to identify and remove incrementing integers merely used to differentiate similar configuration entries. The iterative comparison is performed by comparing one entry (e.g. entry 13) successively with all other entries of the same level (e.g. with entry 14, entry 15, entry 16) to handle situations whereby similar configuration entries are interlaced. For instance entry 13 is similar to entry 15 and entry 14 to entry 16. Hence why it cannot be just a comparison of one entry with the next one. Each comparison is performed ignoring words that are common in both entries. The remaining words (e.g. “1” and “2” with the comparison between entry 13 and entry 15) are analyzed to determine if they are two integers and if the difference between these integers is 1 in order to identify an increment of integers (in case the integer “2” is encountered for one entry an implicit integer “1” may be assigned to the other entry to handle situations such as first entry: “server address” and second entry: “server 2 address”). The position of incrementing integers identified in the strings is memorized with flag entries that contain these integers so that the integers may easily be removed from entries when necessary.

Once two similar entries have been identified (e.g. entry 13 and 15), the comparison resumes from the latter entry (i.e. entry 15) with the remaining level entries. This process is repeated until all level table entries have been reviewed, after which integers that were memorized during the comparison are removed as explained above. For instance this would cause entries 13 and 15 to be both changed respectively from “SNMPv2 server 1 address” and “SNMPv2 server 2 address” to “SNMP server address”. The comparison process is applied again to entries which were not considered similar during the previous comparison (i.e. entries 14 and 15) starting from the entry which follows the entry used to start the previous comparison (i.e. entry 14, following entry 13). Similarly this would cause entries 14 and 15 to be both changed respectively from “SNMP server 1 port” and “SNMP server 2 port” to “SNMP server port”. The comparison process is repeated until all entries were considered similar or used as a starting point for one of the comparisons. If needed, the same process may be adapted to detect decrementing integers should integers in similar configuration entries be inserted in decrementing order.

At step S131, a stemming process is applied. Web interfaces may have similar words based on the same root (e.g. “networking” for entry 3, “network” for entry 9, . . . ). Equally with step S130, these words are different from a string comparison standpoint despite being the same for the purpose of searching a database. Several methods may be used such as looking up tables containing predefined substitution patterns ([networking, networks, networked, network->network]) or using rule-based algorithms. Applying such stemming process on the content table CNT may allow redundant words to appear (e.g. “networking” and “network” respectively in entries 3 and 9 being both replaced with the stem “network”) and be removed at a later stage. Also stemmed words being more suitable for sub-string searches, this may improve the matching of results by the database while saving the database to use more resource-consuming stemming patterns or algorithms.

At step S132, generic terms are removed. In addition to specific terms such as “multicast” or “firewall”, web interfaces also contain more generic terms to explain a configuration options such as “enable” or “disable”. These generic terms are more likely to be replaced with other similar words in database articles and potentially prevent a match (e.g. “firewall” is unlikely to be replaced by any other word, whereas “enable” could easily be replace by “activate” or “turn on”). Being generic, these terms are also more likely to appear in non-related database articles which could potentially degrade the pertinence of matches. One issue is that some generic terms—such as “allow” which may be replaced by terms such as “permit” or “authorize”—are also used as part of specific composed terms—such as “allow list” comprising “allow” which is unlikely to be replaced by any other term—in such a way that removing those generic terms without taking into consideration those specific composed terms could alter specific terms—such as “allow list” becoming “list” after removing “allow”. In order to remove generic words from the content table CNT, a dictionary is used which provides generic terms and lists specific composed terms based on these generic terms. For each word in each entry of the content table CNT, a lookup of the dictionary is performed. If a matching generic term is found for that word and none of the specific composed terms associated with that generic term can be matched with the remaining words of the corresponding entry, then the word is removed, otherwise it is kept.

At step S133, the content table CNT is reviewed for duplicate and empty entries to be removed. Any empty entry may be removed. However, only words or entries that are identical to a parent word or entry may be removed, thus preventing parent words or entries from being altered, as the same parent entry can be later combined with several other entries.

In the above example of table 15, table CNT processed by normalization sequence become as follows:

TABLE 16

| Entry | | | | |
|---|---|---|---|---|
| N° | Level | OBJ ID | OBJ Val | Flag |
| 1 | LV3 | Device | router1000 | M |
| 2 | LV3 | Version | 1.2.3 | M |
| 3 | LV3 | Keyword | network | D |
| 4 | LV4 | Keyword | Security | D |
| 5 | LV5 | Keyword | multicast | D |
| 6 | LV5 | Keyword | firewall | D |
| 7 | LV4 | Keyword | address | D |
| 8 | LV5 | Keyword | gateway | D |
| 9 | LV5 | Keyword | DNS server | D |
| 10 | LV4 | Keyword | monitor | D |
| 11 | LV5 | Keyword | SNMPv2 server address | D |
| 12 | LV5 | Keyword | SNMPv2 server port | D |

As it can be noticed, entries 13, 14, 15 and 16 were simplified at step S130 and, with the removal step S133, were merged into two entries. Words such as “addresses” or “monitoring” from entries 9 and 12 were stemmed to “monitor” and “address” during step S131. Words such as “disable” or “enable” were removed as generic terms during step S132. Also at step S133, the word “network” from entry 9 was for instance removed as it was redundant with the parent entry 3 which had been previously stemmed from “networking” to “network”.

A query table QUT is then created from content table CNT at step S76. Entries in table CNT are flagged with “M” for “metadata” or “D” for “data” because these two types of entries are processed differently. Separate metadata elements may apply to a same data: the numerous meta declarations in a HTML head apply to data in the body. Therefore the sibling meta entries are considered as a whole. In contrast, separate data elements typically represent distinct web interface objects such as headings or labels and should be considered as such.

When reading table CNT, entries corresponding to configuration options (such as label elements) have a higher level as they were parsed and added to table CNT as part of the last child nodes of a particular element, such as entry 6 “firewall” from Table 16 which has a level of 5 and is part of the node T7. Since these entries represent distinct configuration options (so potentially as many issues to search for in a database), they dictate how many queries will be generated. Other entries which have a lower level because they were encountered before, such as entry 4 “Security” from Table 16 which has a level of 4 and is part of the T7 node but was encountered before, do not correspond to specific configuration options, and should not be used as a base for writing queries. Instead such entries should only be used to enrich the content of queries, in a similar way that a heading element is placed before configuration options to give these options more meaning by providing a context.

The reason for creating the content table CNT in the first place is to allow for some normalization tasks to be applied and optimize the web interface content for the purpose of writing queries. However by doing so the document structure—which allows a parser to determine whether an element is parent of another—is lost. For instance by looking at table 16, it does not appear clearly which of entries 7 and 10, which both have a level of 4 should be considered as parents of entry 12 which has a higher level of 5.

One solution would be, while creating the content table CNT, to include the document path of each element—for instance use the Xpath strings “/html/body/div[2]/h2”, “/html/body/div[2]/h2[2]”, and “/html/body/div[2]/div[2]/label[4]” respectively for entries 7, 10 and 12—and compare these paths to determine the parent-child relation. In this case entry 10 is parent of entry 12 because the path of the former is included in the path of the latter, which it is not true when comparing entries 7 and 12. The problem with this approach is that it involves comparing strings, which is known to be slower than comparing integers.

A proposed method inspects the level of content table CNT entries represented as integers and is therefore faster. For a given entry, the direct parent entry is the first entry found up table with a lower level (e.g. for entry 12 it is entry 10). This process is repeated for and from each identified parent until all the table was reviewed (e.g. for entry 10 it is entry 3 and for entry 3 nothing). Thus for instance it can be determined that entries 3 and 10 are parent to entry 12.

FIG. 23 is a flowchart of a sequence generating a query table QUT from table CNT. This sequence which comprises steps S140 to S149, is performed during step S76 and after the sequence of FIG. 19. At step 140, table CNT is read to check if it contains at least one entry of type “D” (at least a configuration entry) which is not processed. If table CNT contains no entry of type “D” the sequence stops. If table CNT contains at least 1 entry of type “D”, a new round is started at step S141. A new round is performed to review each entry of type “D” in table CNT. The sequence is repeated until there are no more entries of “D” type, which get removed as they are progressively used to write queries.

At step S142, the last entry is searched in table CNT (entry 12 in table). At step 143, entry found at step S142 is parsed and its index in table CNT is memorized as N (N=12 in the example of table 16). At step S144, pairs from the object identifier and object value fields are created from all parent entries of type “M” related to the last entry of type “D”. Sample XHTML code comprises metadata global to a whole document, which could raise question as to why not simply memorize all entries of type “M” for each round. In fact, all entries of type “M” are not memorized once for all the rounds so as to anticipate on potential future evolutions of XHTML standards whereby meta element may only apply to a portion of the document and be declared outside the head, further nested inside the document. It could be noticed that the step S144 is executed once for each entry of type “D” (per round).

At step S145, a pair of object identifier and object value fields is created from the currently read entry of type “D” (in the example of CNT table 16, [“keyword”, “SNMP server port”] for entry 12). At step S146, entries of type “D” that have a lower level up in table CNT are searched (amongst entries 11 to 1). Entries that have the same level are not searched because they represent other configuration entries (such as entry 11 or 6). The next entry with a lower level is entry 10. At step S147, the entry found at step S146 (entry 10) is parsed and processed from step S145. Thus a new pair of object identifier and value fields is created for the new entry found at step S146 ([“keyword”, “monitor”] is thus created for entry 10).

Steps S146, S147, S145 are repeated until all entries of type “D” up in table CNT with a lower level are processed. In the example of CNT table 16, the last entry parsed is entry 3. The execution of the sequence continues at step S148 where an entry is inserted in the query table QUT with all the pairs memorized at steps S144 and S145. Pairs that share the same object identifier are then merged into pair containing the shared object identifier and the concatenated object values separated by an object value separator (Field F16) read in the action profile APRF. In the example of table 16, the pairs [“keyword”, “SNMP server port”], [“keyword”, “MONITOR”], [“keyword”, “NETWORK”] are merged into a single pair [“keyword”, “SNMP server port monitor network”]. At the end of step S148, query table QUT is as follows:

TABLE 17

| Query ID | Pairs |
|---|---|
| Query1 | [“device”, router1000], [“version”, “1.2.3”], |
| | [“keyword”, “SNMP server port monitor network”] |

At step S149, the entry which index was memorized at step S143 is removed because it was used in this round to create a query and should not be used in another round to create another query (entry N=12 removed). Then it is determined whether other entries with a lower level found at step S146 should be removed, as indeed, although not of any use for the current round because already part of the query created at step S148, they may be used to enrich other queries during subsequent rounds. This may be determined as follows: only entries of type “D” which are parent (i.e. related) and precede immediately the entry found at step S143 (i.e. are not needed for other “D”-type entries) are removed.

The method applied by the sequence of FIG. 23 assumes that XHTML web interface pages are coded in a nested way so that configuration options are grouped together and that other semantic elements have a lower level in such a way that the document structure enables the use of element level to decide which entries to combine together (here labels are placed within “divs”, and “h2” elements are placed outside the “div”). Although evolution of HTML towards XML leads to elements that can be declared in such nested way, this may however not always be the case, since it is not required to make the web interface functional. To overcome limitations whereby element level could not be used as a differentiator, a predefined list defining the relative content hierarchy may be used to weight the actual element level. An example of a relative content hierarchy is provided in the following table:

TABLE 18

| Weight | HTML tags |
|---|---|
| 1 | Meta, title |
| 2 | H1 |
| 3 | H2 |
| 4 | H3 |
| 5 | H4 |
| 6 | H5 |
| 7 | H6 |
| 8 | Label, span, p |

An example of application of such a relative content hierarchy is provided with the following source code:

<h1>NETWORK ADDRESSES</h1>
<label>gateway</label><input type=″input″ name=″option1″/>
<h1>MONITORING</h1>
<label>SNMP server address</label><input type=″input″
name=″option2″/>

Processing of the above source code with a weighted level provides the following query table QUT:

TABLE 19

| Entry ID | Level | Weighted level | OBJ ID | OBJ Value |
|---|---|---|---|---|
| 1 | 3 | 5 (3 + 2) | keyword | Network address |
| 2 | 3 | 11 (3 + 8) | keyword | gateway |
| 3 | 3 | 5 (3 + 2) | keyword | monitoring |
| 4 | 3 | 11 (3 + 8) | keyword | SNMP server address |

By relying on the mere level, the method as described above would result in four separate queries from entries 1, 2, 3, and 4. By calculating and using a weighted level, the method now produces 2 queries with combined entries 1,2 and 3,4.

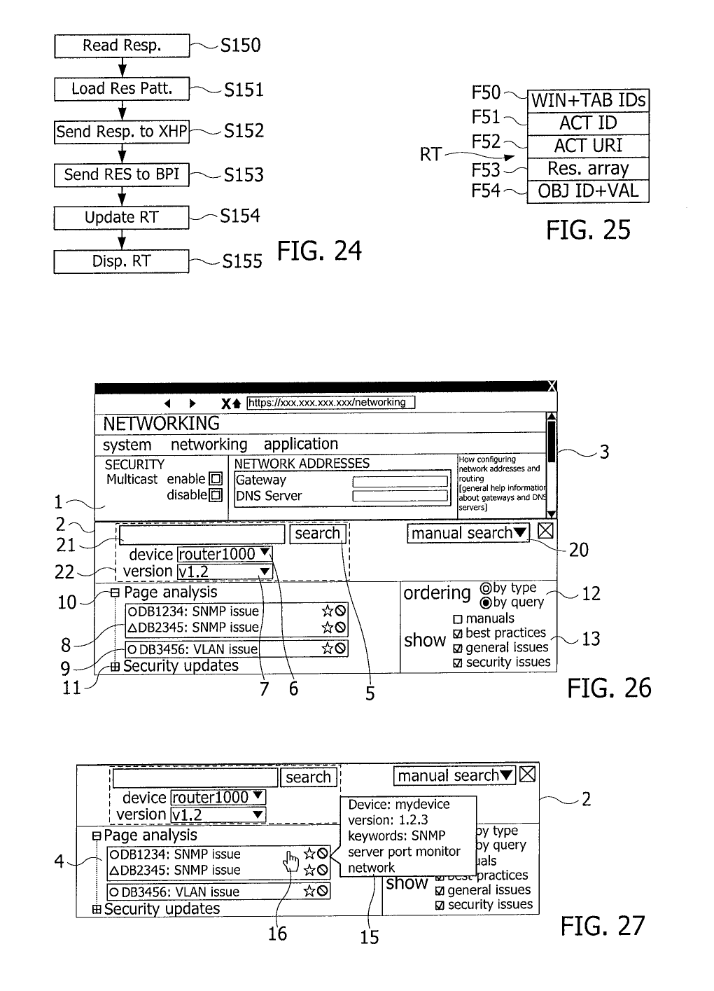

FIG. 24 is a flowchart of a sequence of steps S150 to S155 provided for retrieving and processing a result page supplied by a database SBD (step S40 in FIG. 6). This procedure resumes when the controlled browser CWB has finished loading the data obtained following the last object function call. At step S150, the response from the queried database SDB are received by browser CWB. The response may be received in various formats, such as a XHTML page, should the search be submitted using an HTML form, or a JSON-encoded string should the search be submitted using an AJAX call. Regardless of the method used to submit the search, the response is retrieved from browser CWB only when the last element function call is complete, and obtained from the browser CWB document object model to ensure the response is available in its XHTML form. The response being retrieved in its XHTML form, it could be sent to component BPI and displayed as such inside browser WBR user interface.

However the response is further processed to determine whether it contains any results. Moreover, displaying the response as received would create the following usability problem: to be used concurrently while operating on the network device, component BPI user interface only occupies a portion of the display window of browser WBR. Database web interfaces are usually designed to be accessed in a browser window opened in full screen in order to make optimum use of the available space. Consequently displaying the database response in a smaller area such as display area 2 in FIG. 26 (further described below) would not be practical for users who would be required to scroll horizontally and vertically within the result area to visualize the entire response. Finally, processing the response enables for additional features such as filtering or grouping of results to be implemented inside the BPI user interface.

Something may go wrong between the moment the action is performed, that is the last object function call (step S39-S85-), and the moment a response is received from the queried database (step S40), for instance a HTTP server error response code is returned, or a connectivity issue causes the action to timeout. In such a case, module EVTM should not continue with processing the response. Besides, if a query table QUT was created during step S76, steps S150-S155 are repeated for every entry in table QUT.

At step S150, the data received by browser CWB are retrieved. At step S151, the result extraction patterns (field F18) corresponding to the action profile APRF loaded at step S31 are retrieved. Similarly to the content extraction patterns which allow identifying the relevant XHTML elements from the network device web interface, the results extraction patterns in field F18 allow identifying and extracting the relevant XHTML elements in the pages received from the database web interfaces. However there is a key difference between extracting results, which treats each result separately, and analyzing the page content of the network device web interfaces whereby the pages are processed as a whole. In order to process each result separately, the result extraction patterns comprise a result separator which identifies the XHTML element wrapping a result, and control mappers which map particular XHTML content with controls of the user interface of component BPI.

At step S152, the results and the result extraction patterns retrieved respectively at steps S150 and S151 are sent to parser XHP for processing. Based on the example of source code 7 in Annex III, the result separator may be represented by the following Xpath string: “//table[@id=“resultTable”]/tbody/tr/td”. Selecting elements using the above Xpath string provides parser XHP with a collection of two <td> elements that can be iterated over. This allows parser XHP to return an array to module EVTM containing each processed result in a separate element.

For each element in that collection, parser XHP applies the control mappers of the user interface of component BPI to the inner HTML code of that element, so that information can be extracted out of the results and stored following the structure of the user interface. Each mapper comprises:

an element selector which indicates which element to select within the result,

a value locator which indicates what value to retrieve from that selected element, and

a control type of the user interface of component BPI, which indicates which type of control to use to display that value.

The value locator may refer to a predefined value, the value from an attribute of the selected element, or a parser method to be applied to the selected method which result will be used as the value. Examples of control mappers and types are listed in the following table:

TABLE 20

| | control type | element selector | value locator |
|---|---|---|---|
| 1 | image | //img[@class=“result-img”] | {src} |
| 2 | link | //a[@class=“result-link”] | {href} |
| 3 | link text | //a[@class=“result-link”] | [innerText] |
| 4 | description | //span[@class=“result-info”] | [innerText] |
| 5 | result-type | //input[@class=“result-type”] | {value} |

The first entry in the above table indicates to get the value of the “src” attribute from the <img> element with the “result-img” class. This provides a pair of control type and value as follows: [image, “/img/icons/general-issue.png”]. It should be noted that in order to reuse linked content from the web interface of database SDB (such as <img> or <a> elements) within the user interface of component BPI, URL paths should be converted to full URIs. Assuming the web interface of database SDB was accessed over HTTP at the host “support.myvendor.com”, this would produce the pair [image, “http://support.myvendor.com/img/icons/general-issue.png”]. The second entry indicates to get the value of the “href” attribute from the <a> element with the “result-link” class. With the path conversion this produces the following pair: [link, “http://support.myvendor.com/articles/art1234.html”]. The third entry indicates to get the inner text of the <a> element with the “result-link” class, which produces with source code 7: [link text, “DB1234-VLAN trunking issue”]. The fourth entry indicates to get the inner text of the <span> element with the “result-info” class:=, which produces [description, “Lorem ipsum [ . . . ]”]. The fifth entry indicates to get the value of the “value” attribute from the <input> element with the “result-type” class, which produces [result-type, “general-issue”].

These five pairs represent the processed result corresponding to the first <td> element in source code 7, which should be returned as part of one result array element. Following the sample results, another set of five pairs should be created and added as another element to the result array. Parser XHP then returns this result array to module EVTM. If after processing by parser XHP, it appears that no results were returned by the queried database SDB, an empty result array is returned to module EVTM.

At step S153, the result array is received by module EVTM from parser XHP, and sent to component BPI in a notification that contains the following information:

F50: window and tab identifiers corresponding to the current entry of the event table ET, so that a result displayer knows in which window and tab to display the results, for example “0,0”;

F51: current action identifier, for example “Page analysis”;

F52: the URI corresponding to the current entry of table ET, for example “https://192.168.1.10/networking”;

F53: the result array received from parser XHP; and

F54: the object identifiers and values as submitted during step S85, for example “[“device”, “router1000”], [“version”, “1.2.3”], [“keyword”, “SNMP server port monitor network”]”.

Unlike event reporters ERP which creates an entry in table ET at step S12 before notifying module EVTM with the same information at S13, in order to follow the execution of module EVTM by detecting the later removal of the entry by module EVTM, the latter does not need to follow the execution of component BPI regarding the displaying of results, because after sending the results to component BPI at S41, the only tasks left for module EVTM are to close the relevant tab of browser CWB and cleanup table ET which occur unconditionally and irrespectively of other components. Accordingly notifying component BPI directly with the results is more efficient than updating an intermediate table first before notifying component BPI.

If no results were returned by the queried database SDB, the notification contains an empty result array. This allows component BPI user interface to notify the user with a message that no relevant information was found in the queried database. This notification improves the user experience compared with not displaying any information at all, which may raise uncertainty over the proper functioning of component BPI, the connectivity with the database or other aspects.

At step S154, component BPI inserts the information received following the notification of module EVTM at S153 into the result table RT. Table RT is not used to display the results received from module EVTM as these results may be rendered directly, instead, table RT provides a history of information established during previous actions, which may be reused to optimize the execution of new actions. For instance, as part of collecting the notification information at step S11, an event reporter ERP may lookup result table RT and reuse the “device” identifier value of a relevant result table entry, thus saving module EVTM from undergoing a device identification.

The result displayer has default methods for rendering each control of the user interface of component BPI, depending on the type of the latter, and also depending on the interface language of the user interface of component BPI. For instance if the user interface of component BPI is based on XUL (http://en.wikipedia.org/wiki/XUL), a conversion table may be used to convert the database web interface page elements to XUL elements (for instance <span> are converted into <description> elements, <img> into <image> elements). For an Internet Explorer BHO, calls to predefined functions may be used to create controls.

FIG. 26 represents a web browser window appearing in particular when component BPI displays query results. The window comprises a first display area 1 where the web page of FIG. 20 is displayed, and a second display area 2 used as a user interface of component BPI. By comparison with FIG. 20, the height of display area 1 is reduced, hence triggering display of a scroll-bar 3. Display area 2 may be pulled up automatically whenever results are obtained from a database or openend manually by the user. Having display area 2 take only a portion of the browser window enables users to operate on the network device and at the same time to have access to the query results or to perform manual searches.

Display area 2 comprises buttons 10, 11 for triggering expansion or contraction of display zones, each button being associated with a title corresponding to the name of the corresponding action profile (“Page analysis”, “Security updates”). In the example of FIG. 26, result display zones 8, 9 are expanded using button 10, whereas the display area corresponding to button 11 is collapsed. The display zones 8 and 9 display results that were obtained. Display area 2 comprises checkboxes 12 allowing to choose how to group the results, by type or by query. In the example of FIG. 26, the results are grouped by query. Grouping results per query allows users to focus on related results, whereas grouping results per type allows users to focus on certain types of results, for instance focus on all security issues regardless of the query they were obtained with. Grouping results is achieved without having to send new queries to the database, thanks to the fact that the necessary information has been stored in the result table RT. Upon checking one of these two buttons, the result displayer may look up the current window/tab identifier and URI (fields F50, F52) and use that information to identify the relevant entries in the result table RT. Then the necessary result display zones 8, 9 may be recreated to display results on a per-type basis. Similarly another feature is to filter the results based on their type. Upon checking one of the check-boxes 13, the same steps used to order results with the buttons 12 may be followed while performing an additional verification on the result type and displaying only results matching one the checked check-boxes 13.

Display area 2 comprises a dropdown list 20 allowing the user to change the action to be performed manually. Controls used for performing the manual action are created based on the action mapping table of the corresponding action profile. For instance, FIG. 26 shows the “Manual Search” selected. Accordingly, the user interface of component BPI comprises a control 6 corresponding to the mapping table field F31, a control 7 corresponding to the mapping table field F32, etc. . . . .

Although not presented in FIG. 3, another event reporter ERP may be created and associated with the “Security Updates” action to allow the user searching for security related issues manually. Accordingly, the “Security Updates” value would be added to the dropdown list 20, and when selected, the controls associated with the previously selected action would be replaced by new controls matching the mapping table objects F34 to F39. The collapsible display areas corresponding to buttons 10, 11 are created for the current actions which will operate as a container for the results. Using such collapsible areas allows the user to contract and expand areas to show and hide results depending on the action. For instance the collapsed area corresponding to button 11 contains results hidden for a security update action that occurred on the same window or tab.

Next to the button 10 is an action label which is based on the name F11 of the current action profile APRF, thus allowing the user to understand how the results were gathered. Contained within the result display zones 8, 9 are the results grouped by query. A frame delimiting each display zone 8, 9 materializes that grouping and enables users quickly understanding which results were obtained from the same query and are therefore more likely to be related. Inside the display zones 8, 9, each result is displayed on one line.

According to an embodiment, the user interface of component BPI can display the object identifiers and object values used for each search. This feature may help the user to improve his searching skills, in view of performing manual searches by showing him examples as to which keywords choosing to obtain pertinent results. FIG. 27 shows another view of the display area 2 only, displayed by component BPI. In FIG. 27 a dialog box 15 is displayed when the mouse is moved over the result display area 8. The dialog box 15 displays the device, version and keyword object identifiers and corresponding object values used for the corresponding search (query 1 in the above table 16). If the user needs to perform subsequent manual searches, he may reuse some of the feedbacks he received. The object identifiers and values displayed in the dialog box 15 may either be inserted into component BPI web interface at step S154, but hidden when displaying the results, so that the dialog box information may be obtained directly from the user interface of component BPI. Alternatively, they may be collected on demand from the result table RT in which case the user interface of component BPI may for each result display area, contain an identifier allowing to identify the corresponding result table entry to retrieve the necessary information when needed.

The device identification may reuse information gathered during earlier device identification tasks (step S24). The event reporter ERP relative to event E1 may be modified in order for the HTTP referrer header information (http://en.wikipedia.org/wiki/ List_of_HTTP_header_fields) to be collected from the client request and compared with the entries of table RT to identify an entry with a URI (field F52) matching the referrer. The entry should be related to actions where the device identification step S24 is performed such as a page analysis action, to prevent device non-specific information to be reused, such as predefined object identifiers provided via manual searches which may be related to any device or version.

Should a result table entry be identified based on the HTTP referrer, the object identifiers and corresponding values F54 contained in that entry may be sent to module EVTM via the initial notification (step S20), as part of the predefined object identifiers and corresponding values (field F8 in table ET). However, only the object identifiers that are related to the device itself, such as the “device” or “version” object identifiers, should be reused. Reusing other object identifiers which are action specific, such as the “keyword” object identifier, would be inappropriate as it would result in the loaded mapping table to be filled up with the same data during steps S37, S71, resulting in the same action to be performed over and over again. To prevent this, a flag may be associated with each object identifier, starting from the mapping table and maintained throughout the various processes and other tables, indicating whether an object identifier is device-specific, in which case it may be reused.

It should be noted that the process of reusing the object identifiers from table RT may also be applied to other event reporters ERP, such as the timer event reporter E7 used to search for security updates. Instead of inspecting the HTTP headers which may not be available for these event reporters ERP, another way of identifying a relevant entry in table RT would be to use the URI value contained in the browser address bar for the relevant browser window or tab instead of the HTTP referrer header.

From time to time users may decide to perform manual searches not specific to the network device they are operating on, for instance in order to find information about issues affecting other devices or versions which may have not been reported or documented for the current network device. Moreover, users may be administrating several network devices at the same time and it might become difficult for them to remember the exact model and version of each of these network devices. The user interface of component BPI may be extended to allow the user to quickly find out which network device he is operating on and help him reset the controls of component BPI to match the current network device by displaying the current device information and highlighting the user interface controls with matching values.

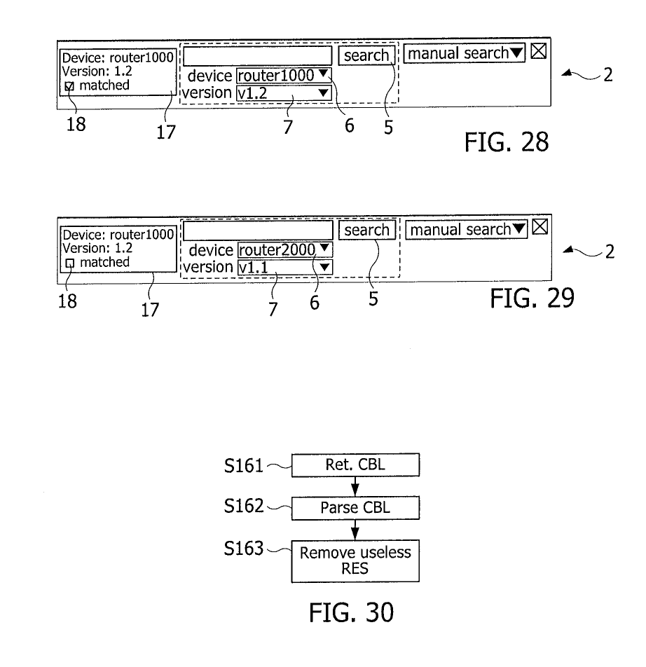

FIGS. 28 and 29 show a search form which is displayed in the user interface of component BPI. The device specific object identifiers and values are displayed within a frame 17 which may be highlighted. Inside the frame 17, is a check-box 18 which indicates whether the values of all device specific controls, device and version controls 6 and 7, match the object value of the corresponding object identifier as established during the device identification which are stored in the result table RT and displayed inside the frame 17. As explained earlier, only actions during which a device identification is performed may be used for that. In FIG. 28, the check box 18 is checked, meaning that the values assigned to controls 6 and 7 match the values of object identifiers for the detected device, as displayed inside frame 17. In FIG. 29 the checkbox 18 is unchecked and the device and version controls 6, 7 are not highlighted as the user changed their values which no longer match that of the current network device. The user may easily reset both controls 6, 7 to match the current device by checking check-box 18 again. In addition to the device and version controls, a network device manufacturer may implement other device specific controls such as references to the underlying hardware platform, hotfix level and software modules enabled on the network device, increasing the benefits of this feature as managing an increasing number of controls may become more difficult to the user.

Software used to operate network devices, like any other software, contains bugs, some of which get corrected as the system undergoes software updates. Accordingly articles provided by databases SDB related to those corrected issues should not be displayed to the user. One of the issues a manufacturer faces is to keep the existing database documentation up-to-date when new bugs are discovered or fixed or new versions released, as this involves reviewing existing articles to see whether they apply to these new situations. This may become time consuming when the number of new software releases and bugs increases. Due to this time, there may be discrepancies between the information contained in the database and the actual state of the software. For instance an article no longer applies to a particular software version but has not been updated yet. Accordingly, providing specific device and version information during a search may not be sufficient to exclude non-related articles out of the results.

On the other hand, it is easier for a product development team to indicate whether a particular bug was fixed or not in a software release as bug tracking systems are used as part of the software development process to document bugs and specify in which software release they are corrected and which software release remain affected. Accordingly, using the list of corrected bugs provided by product development instead of only relying on database search criteria might improve the pertinence of search results. Thus the network device web interface should be updated to provide lists of corrected bugs, for instance via a particular page predefined in the device profile. Upon loading the device profile at step S30, module EVTM would read the page URL and retrieve the list of corrected bugs.

A first way of excluding those corrected bugs out of the search results would be to provide bugs as an exclusion list, for instance as part of the search keywords using special search operators. The first problem with this method is that it might be bandwidth consuming as each query would be extended to include hundreds or thousands of bug identifiers. The second problem is that it might be resource consuming for the database search engine which will, for each query, compare every result with all those identifiers. According to an embodiment, a second approach is to perform this filtering process by module EVTM, to address those issues by not including the identifiers in the query and delegating the processing of results to module EVTM.

FIG. 30 is a flowchart of a sequence of filtering out search results, executed by module EVTM, based on known corrected bugs. This sequence comprises steps S161 to S163. At step S161, component BPI performs a HTTP request to the network device at a predefined URL when the device profile DPRF is loaded at step S30 to retrieve a corrected bug list (CBL). An additional field is provided in the device profiles DPRF to include that URL (CBL URL: /61).

At step S162, module EVTM parses CBL list received when the network device replies to the HTTP request sent at step S161. Instead of relying on a method similar to the content analysis with the content extraction patterns, all that module EVTM needs at this point is the syntax used to define bug identifiers and locate those identifiers within the response. For instance, “BUG12345”, “BUG23456”, and “BUG34567” may be parsed with the bug identifier syntax is BUG[0-9]*, according to the following response:

```
<?xml version=″1.0″ encoding=″UTF-8″?>
<cbl>
  <buildnumber>123.456</buildnumber>
  <content>BUG12345, BUG23456, BUG34567</content>
</cbl>
```

To avoid having to perform steps S161 and S162 for every action, module EVTM should cache the list CBL when parsing it for the first time so that it may be re-used during subsequent actions, bearing in mind that a particular device profile DPRF may apply to a plurality of network devices running different software versions, and that the list of bugs may vary from one version to another. Accordingly, when saving a parsed list CBL for a particular device profile, module EVTM may keep a record of the network device software version so as to re-use the same list CBL only when a network device with a same version is encountered. In order to determine which object identifiers and their associated values may be used for the record of the a software version, flags may be associated with the relevant mapping table entry. Alternatively, should the object identifiers defined in the mapping table provide an insufficient level of precision to determine which bugs are corrected on a network device, other object identifiers could be used—for instance a hotfix level applied to a software version.

At step S163, the sequence continues when results are received from parser XHL following the processing of the response returned by the database SDB. In order to remove unnecessary results, that is results related to corrected bugs. The XHTML code returned by the queried database SDB should contain, for each result, a list of related corrected bugs. Source code 8 is an example of source code received from a database. The bug identifiers are stored within a hidden input element. Similarly to the other result extraction patterns, another pattern may be used to parse that input element and retrieve its attribute value along with the bug identifier syntax to identify individual bug identifiers within that value, although relying on the bug identifier syntax to dynamically identify the bugs within each result may be sufficient. Finally, those identifiers should be compared with the ones in CBL list, in order to remove results which related bugs have all been corrected, that is, are present in list CBL associated with the network device version. In the example of source code 8, the first result would be removed because both “BUG12345” and “BUG23456” are found in the CBL list. Besides the second result should not be removed because despite “BUG34567” being found in the CBL list, the other bug “BUG45678” is not in this list.

The terminology used therein is for the purpose of describing particular embodiments only and is not intended to be limited of the disclosure. As used therein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but it is not intended to be exhaustive or limited to the disclosure in the form disclosed. Many modifications and variation will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### Annex I

TABLE ET

| | | APRF | WIN/Tab | | Cur. | Last | EVT | Pred. |
|---|---|---|---|---|---|---|---|---|
| | ERP ID | ID | ID | URI | EVT | EVT | data | OBJ ID |
| | Field F1 | F2 | F3 | F4 | order F5 | order F6 | F7 | F8 |
| 1 | 3522 | | 1,1 | https://10.10.10.1/index.html | E4 | E5 | | |
| 2 | 3525 | | 1,1 | https://10.10.10.1/index.html | E6 | E6 | | |
| 3 | 3532 | | 1,2 | https://10.10.10.2/system.html | E2 | E5 | | |
| 4 | 3540 | | *,* | https://10.10.10.1/index.html | E7 | E7 | | |
| 5 | 3544 | | *,* | https://10.10.10.2/security.html | E7 | E7 | | |
| 6 | 3545 | | 1,2 | https://10.10.10.1/index.html | E3 | E5 | | |
| 7 | 3550 | | 1,1 | null | E8 | E8 | | |
| 8 | 3555 | | 1,2 | https://10.10.10.1/index.html | E2 | E5 | | |

### Annex II

Example of Table DPRF

| | Pred. OBJ ID, | DV ID patt. | Content Extraction | DV filters. | ACT Filters Parameters |
|---|---|---|---|---|---|
| | Val (field F20) | (field F21) | Patterns (field F22) | (field F23) | (field F24) |
| 1 | [device,router.*] | [E1,Cookie:.*myvendor-router.*] | see tables | [E1,is_help_section? | [is_page_final, |
| | | [E2,Set-Cookie:myvendor-router.*] | below | ($URI,$help_section_path)] | //ul[@id=“mainMenu”] |
| 2 | [device, | [E1,Cookie:.*myvendor-firewall700.*] | see tables | [E1,is_help_section? | [is_page_final, |
| | firewall700] | [E2,Set-Cookie:myvendor-firewall700] | below | ($URI,$help_section_path)] | //ul[@id=“navigation- |
| | | | | | menu”] |
| 3 | [device, | [E2,WWW-Authenticate: Basic realm= | see tables | null | [is_page_final, |
| | switch100] | “myvendor-switch100”] | below | | //table[@id=“navMenu”] |
| | | [E3,.*meta name=“device” content= | | | |
| | | “switch100”.*] | | | |
| 4 | [device: *] | null | null | [E6, always_true( )] | null |

### Content Extraction Patterns (Field F22):

Inclusion patterns

| | Selector | OBJ ID locator | OBJ Val locator | type |
|---|---|---|---|---|
| 1 | //meta | {name} | {content} | M |
| 2 | //body/descendant::* | “keyword” | [innerText] | D |

Exclusion patterns

| | Selector |
|---|---|
| 1 | //ul, //dl |
| 2 | //div[@id=“help”] |
| 3 | //p |

### Annex III

Source Code 1

```
<ul id=″menu-left″>
  <li><a href=″/A1″>A1</a>
  <ul>
  <li><a href=″/A1-1″>A1-1</a></li>
  <li><a href=″/A1-2″>A1-2</a></li>
  </ul>
  </li>
  <li><a href=″/A2″>A2</a></li>
  <li><a href=″/A3″>A3</a></li>
</ul>
```

Source Code 2

```
<ul id=″menu-top-1″>
  <li><a href=″/B1″>B1</a></li>
  <li><a href=″/B2″>B2</a></li>
  <li><a href=″/B3″>B3</a></li>
</ul>
```

Source Code 3

```
<ul id=″menu-top-1″>
  <li><a href=″/C1″>C1</a></li>
  <li><a href=″/C2″>C2</a></li>
  <li><a href=″/C3″>C3</a></li>
</ul>
```

Source Code 4

```
<ul id=″menu-top-2″>
  <li><a href=″/D1″>D1</a></li>
  <li><a href=″/D2″>D2</a></li>
</ul>
```

Source Code 5 - Network device web interface source code

```
<!DOCTYPE html PUBLIC″-//W3C//DTD XHTML 1.0 Strict//EN″
  ″http://www.w3.org/TR/xhtml1/DTD/xhtml1-strict.dtd″>
<html xml:lang=″fr″ xmlns=″http://www.w3.org/1999/xhtml″ lang=″en″>
  <head>
  <meta name=″device″ content=″router1000″/>
  <meta name=″version″ content=″1.2.3″/>
  <link type=′text/css′ rel=″stylesheet″ href=′style.css′/>
  </head>
  <body>
  <h1>NETWORKING</h1>
  <div id=″menu″>
    <ul>
    <li><a href=″/system″><span class=″label″>system</span></a></li>
    <li><a href=″networking″><span class=″label″>networking</span></a></li>
    <li><a href=″application″><span class=″label″>application</span></a></li>
    </ul>
  </div>
  <div id=″security-settings″>
    <h2>SECURITY</h2>
    <div class=″options″>
    <label>multicast: enable</label><input type=″checkbox″ name=″option1-enable″/>
    <label>disable</label><input type=″checkbox″ name=″option1-disable″/>
    <label>firewall: enable</label><input type=″checkbox″ name=″option2-enable″/>
    <label>disable</label><input type=″checkbox″ name=″option2-disable″/>
    </div>
  </div>
  <div id=″other-settings″>
    <h2>NETWORK ADDRESSES</h2>
    <div class=″options″>
    <label>gateway</label><input type=″input″ name=″option3″/>
    <label>DNS server</label><input type=″input″ name=″option4″/>
    </div>
    <h2>MONITORING</h2>
    <div class=″options″>
    <label>SNMPv2 server 1 address</label><input type=″input″ name= ″option5″/>
    <label>SNMPv2 server 1 port</label><input type=″input″ name=″option6″/>
    <label>SNMPv2 server 2 address</label><input type=″input″ name =″option7″/>
    <label>SNMPv2 server 2 port</label><input type=″input″ name=″option8″/>
    </div>
    <input type=″submit″ value=″save″/>
  </div>
  <div id=″help″>
    <h2>How configuring network addresses and routing</h2>
    <p>[general help information about gateways and DNS servers]</p>
  </div>
  </body>
</html>
```

Source Code 6 - Network device web interface source code after exclusion list

```
<!DOCTYPE html PUBLIC″-//W3C//DTD XHTML 1.0 Strict//EN″
  ″http://www.w3.org/TR/xhtml1/DTD/xhtml1-strict.dtd″>
<html xml:lang=″fr″ xmlns=″http://www.w3.org/1999/xhtml″ lang=″en″>
  <head>
  <meta name=″device″ content=″router1000″/>
  <meta name=″version″ content=″1.2.3″/>
  <link type=′text/css′ rel=″stylesheet″ href=′style.css′/>
  </head>
  <body>
  <h1>NETWORKING</h1>
  <div id=″menu″>
  </div>
  <div id=″security-settings″>
    <h2>SECURITY</h2>
    <div class=″options″>
    <label>multicast: enable</label><input type=″checkbox″ name=″option1-enable″/>
    <label>disable</label><input type=″checkbox″ name=″option1-disable″/>
    <label>firewall: enable</label><input type=″checkbox″ name=″option2-enable″/>
    <label>disable</label><input type=″checkbox″ name=″option2-disable″/>
    </div>
  </div>
  <div id=″other-settings″>
    <h2>NETWORK ADDRESSES</h2>
    <div class=″options″>
    <label>gateway</label><input type=″input″ name=″option3″/>
    <label>DNS server</label><input type=″input″ name=″option4″/>
    </div>
    <h2>MONITORING</h2>
    <div class=″options″>
    <label>SNMPv2 server 1 address</label><input type=″input″ name=″option5″/>
    <label>SNMPv2 server 1 port</label><input type=″input″ name=″option6″/>
    <label>SNMPv2 server 2 address</label><input type=″input″ name=″option7″/>
    <label>SNMPv2 server 2 port</label><input type=″input″ name=″option8″/>
    </div>
    <input type=″submit″ value=″save″/>
  </div>
  </body>
</html>
```

Source code 7 - Sample results of Queryl

```
<table id=″resultTable″>
  <tbody>
    <tr>
      <td>
        <input class=″result-corrected-bugs″ type=″hidden″ value=″BUG12345,
          BUG23456″/>
        <input class=result-type″ value=″general issue″ type=″hidden″/>
        <img class=″result-icon″ src=″/img/icons/general-issue.png″/>
        <a class=″result-link″ href=″/articles/article-1234.html″>
          DB1234 - VLAN trunking issue
        </a>
        <span class=″result-info″>Lorem ipsum [...]</span>
      </td>
    </tr>
    <tr>
      <td>
        <input class=″result-corrected-bugs″ type=″hidden″ value=″BUG34567,
          BUG45678″/>
        <input class=result-type″ value=″security issue″ type=″hidden″/>
        <img class=″result-icon″ src=″/img/icons/security-issue.png″/>
        <a class=″result-link″ href=″/articles/article-2345.html″>
          DB2345 - DNS poisoning issue
        </a>
        <span class=″result-info″>Lorem ipsum [...]</span>
      </td>
    </tr>
  </tbody>
</table>
```

Source code 8 - Sample results of bug list query

```
<table id=″resultTable″>
  <tbody>
    <tr>
      <td>
        <input class=″result-corrected-bugs″ type=″hidden″ value=″BUG12345,
          BUG23456″/>
        <input class=result-type″ value=″general issue″ type=″hidden″/>
        <img class=″result-icon″ src=″/img/icons/general-issue.png″/>
        <a class=″result-link″ href=″/articles/article-1234.html″>
          DB1234 - VLAN trunking issue
        </a>
        <span class=″result-info″>Lorem ipsum [...]</span>
      </td>
    </tr>
    <tr>
      <td>
        <input class=″result-corrected-bugs″ type=″hidden″ value=″BUG34567,
          BUG45678″/>
        <input class=result-type″ value=″security issue″ type=″hidden″/>
        <img class=″result-icon″ src=″/img/icons/security-issue.png″/>
        <a class=″result-link″ href=″/articles/article-2345.html″>
          DB2345 - DNS poisoning issue
        </a>
        <span class=″result-info″>Lorem ipsum [...]</span>
      </td>
    </tr>
  </tbody>
</table>
```

What is claimed is:

1. A method for assisting users with operating network devices, the method comprising steps performed by a computer connected to a network of:
receiving data from the network by a web browser executed by the computer,
analyzing the data received for determining whether the data received is transmitted by a network device for which a user desires assistance,
extracting keywords from the data transmitted by the network device,
generating a query from the keywords extracted from the data received,
sending the query through the network to a web interface of a support database providing support information about operating the network device,
receiving from the network query results transmitted by the support database, and
displaying the query results with a web page transmitted by the network device.

2. The method of claim 1, further comprising generating a query to the support database from keywords entered by a user or from keywords stored in a table.

3. The method of claim 1, wherein the query generation comprises removing similar terms and then generic terms, from the keywords extracted.

4. The method of claim 1, wherein analyzing the data received is performed by a process distinct from the web browser and asynchronously communicating with an additional component of the web browser by means of an event table in which the data received is inserted.

5. The method of claim 4, further comprising:
associating in the event table the data received with events occurring within the web browser, each event being associated with an event occurrence order indicating a link to another event occurring after the event,
selecting device identification patterns in a device profile table, to be applied to the received data, as a function of the event occurrence order corresponding to the event associated with the received data, and
identifying a network device from which the data received is transmitted, by applying the selected device identification patterns to the received data, a particular network device being identified if one of the selected device identification patterns matches a part of the received data.

6. The method of claim 1, further comprising:
collecting keyword values from support databases of network devices for which a user desires assistance,
linking the values collected according to a tree-like structure using relations between values collected, and
using the values collected and the links therebetween to extract the keywords from the data transmitted by a network device for which a user desires assistance.

7. The method of claim 6, wherein the keyword value collection in a support database is performed periodically so as to prevent a disconnection from the support database due to a session timeout.

8. The method of claim 6, wherein the keyword values collected and their tree-like structure are used to replicate the web interface of the support database inside a display area of a browser display window comprising another display area used to display a web page transmitted by a network device.

9. The method of claim 1, wherein the keywords extraction comprises determining respective positions of web pages received from a network device into a tree-like structure defined by links between the web pages received, the keywords being extracted only from web pages selected according to their position in the tree-like structure.

10. The method of claim 1, further comprising processing query results received so that they fit in a display area of a browser display window comprising another display area used to display a web page transmitted by a network device.

11. The method of claim 10, wherein processing the query results is performed by a process distinct from the web browser, and display of the processed query results is performed by an additional component of the web browser.

12. The method of claim 1, wherein an additional component of the web browser asynchronously transmits data received by the web browser to a process distinct from the web browser, and the process parses the data transmitted to determine whether the data transmitted is received from one of the network devices for which a user desires assistance.

13. The method of claim 1, wherein determining that the data received is transmitted by one of the network device is performed using identification patterns designed to match different parts of data in the data transmitted by a network device for which a user desires assistance.

14. The method of claim 1, wherein extracting keywords from the data transmitted by a network device comprises selection of data to be extracted using patterns, and normalization of data extracted to remove redundancies and similarities within the data extracted.

15. The method of claim 1, further comprising transmitting a request to a network device at a predefined URL to retrieve a corrected bug list, receiving a corrected bug list from a network device, locating bug identifiers within the received corrected bug list, and removing from the query results transmitted by the support database the results concerning bug identifiers in the corrected bug list.

16. A computer system configured to be connected to a network and comprising:
a web browser configured to receive data from the network, the system being configured to:
analyze the data received for determining whether the data received is transmitted by a network device for which a user requires assistance,
extract keywords from the data transmitted by the network device,
generate a query from the keywords extracted from the data received,
send the query through the network to a web interface of a support database providing support information about operating the network device,
receive from the network query results transmitted by the support database, and
display the query results with a web page transmitted by the network device.

17. The computer system of claim 16, further configured to generate a query to the support database from keywords entered by a user or from keywords stored in a table.

18. The computer system of claim 16, further configured to generate the query by removing similar terms and then generic terms, from the keywords extracted.

19. The computer system of claim 16, comprising a process and a web browser comprising an additional component, the web browser being configured to receive data from the network, the additional component being configured to transmit the data received to the process, and the process and the additional component being configured to asynchronously communicate with each other by means of an event table in which the data received is inserted.

20. The computer system of claim 19, wherein the additional component is configured to transmit a notification to the process each time a new event starting a new chain of events is detected within the web browser.

21. The computer system of claim 16, configured to:
associate in the event table the data received with events occurring within the web browser, each event being associated with an event occurrence order indicating a link to another event occurring after the event,
select device identification patterns in a device profile table, to be applied to the received data, as a function of the event occurrence order corresponding to the event associated with the received data, and
identify a network device from which the data received is transmitted, by applying the selected device identification patterns to the received data, a particular network device being identified if one of the selected device identification patterns matches a part of the received data.

22. The computer system of claim 16, configured to:
collect keyword values from support databases of network devices for which a user requires assistance,
link the values collected according to a tree-like structure using relations between values collected, and
use the values collected and the links therebetween to extract the keywords from the data transmitted by a network device.

23. The computer system of claim 22, configured to periodically collect the keyword values in a support database so as to prevent a disconnection from the support database due to a session timeout.

24. The computer system of claim 22, wherein an additional component of the web browser is configured to use the keyword values collected and their tree-like structure to replicate the web interface of the support database inside a display area of a browser display window comprising another display area used to display a web page transmitted by a network device.

25. The computer system of claim 16, configured to extract keywords from the data received from a network device by determining respective positions of web pages received from a network device in a tree-like structure defined by links between the web pages received, the keywords being extracted only from web pages selected according to their position in the tree-like structure.

26. The computer system of claim 16, configured to process query results received so that they fit in a display area of a browser display window comprising another display area used to display a web page transmitted by the network device.

27. The computer system of claim 26, comprising a process distinct from the web browser and configured to process the query results received by the web browser, and an additional component of the web browser configured to display the processed query results.

28. The computer system of claim 16, comprising an additional component of the web browser configured to asynchronously transmit all the data received by the web browser to a process distinct from the web browser, the process being configured to parse the data transmitted to determine whether the data transmitted is received from one of the network devices for which a user desires assistance.

29. The computer system of claim 16, configured to determine that the data received is transmitted by a network device by using identification patterns designed to match different parts of data in the data transmitted by a network device for which a user desires assistance.

30. The computer system of claim 16, configured to extract keywords from the data transmitted by a network device by selecting data to be extracted using patterns, and by normalizing data extracted to remove redundancies and similarities within the data extracted.

31. The computer system of claim 16, configured to transmit a request to a network device at a predefined URL to retrieve a corrected bug list, receive a corrected bug list from a network device, locate bug identifiers within the received corrected bug list, and remove from the query results transmitted by the support database the results concerning bug identifiers in the corrected bug list.

32. A non-transitory computer readable medium configured to store computer executable code comprising instructions for controlling a computer, said instructions causing said computer to perform the steps of:
receiving data from a network by a web browser executed by a computer connected to the network,
analyzing the data received for determining whether the data received is transmitted by a network device for which a user desires assistance,
extracting keywords from the data transmitted by the network device,
generating a query from the keywords extracted from the data received,
sending the query through the network to a web interface of a support database providing support information about operating the network device,
receiving from the network query results transmitted by the support database, and
displaying the query results with a web page transmitted by the network device.

33. The computer readable medium of claim 32, wherein the instructions cause the computer to perform the steps of generating a query to the support database from keywords entered by a user or from keywords stored in a table.

34. The computer readable medium of claim 32, wherein the instructions cause the computer to perform the steps of removing similar terms and then generic terms, from the keywords extracted, in order to perform the query generation.

35. The computer readable medium of claim 32, wherein the instructions cause the computer to perform the steps of executing a process distinct from the web browser, and an additional component of the web browser, the instructions cause the process to analyze the data received and asynchronously communicate with the additional component by means of an event table in which the data received is inserted.

36. The computer readable medium of claim 35, wherein the instructions cause the computer to perform steps of:
associating in the event table the data received with events occurring within the web browser, each event being associated with an event occurrence order indicating a link to another event occurring after the event,
selecting device identification patterns in a device profile table, to be applied to the received data, as a function of the event occurrence order corresponding to the event associated with the received data, and
identifying a network device from which the data received is transmitted, by applying the selected device identification patterns to the received data, a particular network device being identified if one of the selected device identification patterns matches a part of the received data.

37. The computer readable medium of claim 32, wherein the instructions cause the computer to
collect keyword values from support databases of network devices for which a user desires assistance,
link the values collected according to a tree-like structure using relations between values collected, and
use the values collected and the links therebetween to extract the keywords from the data transmitted by a network device.

38. The computer readable medium of claim 37, wherein the instructions cause the computer to perform the keyword value collection in a support database periodically so as to prevent a disconnection from the support database due to a session timeout.

39. The computer readable medium of claim 37, wherein the instructions cause an additional component of the web browser to use the keyword values collected and their tree-like structure to replicate the web interface of the support database inside a display area of a browser display window comprising another display area used to display a web page transmitted by a network device.

40. The computer readable medium of claim 32, wherein the instructions cause the computer to extract keywords by determining respective positions of web pages received from a network device in a tree-like structure defined by links between the web pages received, the keywords being extracted only from web pages selected according to their position in the tree-like structure.

41. The computer readable medium of claim 32, wherein the instructions cause the computer to extract process query results received so that they fit in a display area of a browser display window comprising another display area used to display a web page transmitted by the network device.

42. The computer readable medium of claim 41, wherein the instructions cause the computer to process query results by a process distinct from the web browser, and display the processed query results by an additional component of the web browser.

43. The computer readable medium of claim 32, wherein the instructions cause an additional component of the web browser to asynchronously transmit all the data received by the web browser to a process distinct from the web browser, and cause the process to parse the data transmitted to determine whether the data transmitted is received from one of the network devices for which a user requires assistance.

44. The computer readable medium of claim 32, wherein the instructions cause the computer to determine that the data received is transmitted by a network device by using identification patterns designed to match different parts of data in the data transmitted by a network device for which a user desires assistance.

45. The computer readable medium of claim 32, wherein the instructions cause the computer to extract keywords from the data transmitted by a network device by selecting data to be extracted using patterns, and normalizing data extracted to remove redundancies and similarities within the data extracted.

46. The computer readable medium of claim 32, wherein the instructions cause the computer to transmit a request to a network device at a predefined URL to retrieve a corrected bug list, receive a corrected bug list from a network device, locate bug identifiers within the received corrected bug list, and remove from the query results transmitted by the support database the results concerning bug identifiers in the corrected bug list.
